(19) United States
(12) Patent Application Publication
(10) Pub. No.: US 2004/0146221 A1
(43) Pub. Date: Jul. 29, 2004

(54) Radiography Image Management System

(76) Inventors: Scott H. Siegel, Denver, CO (US); Eric J. Nienhouse, Denver, CO (US)

Correspondence Address: KYLE W. ROST, 5490 AUTUMN CT., GREENWOOD VILLAGE, CO, 80111, US

(21) Appl. No.: 10/707,918

(22) Filed: Jan. 23, 2004

Related U.S. Application Data
(60) Provisional application No. 60/442,609, filed on Jan. 23, 2003.

(51) Int. Cl. G06F 17/60; G06K 9/60; G06K 9/54

(52) U.S. Cl. 382/305; 705/3

(57) ABSTRACT

System for managing radiographic images includes a capture device, a file server, a database server, a user workstation, and a data storage device with removable media. Digital images are captured by the capture device, automatically stored on the file server, maintained as the original image and archived to the data storage device. The workstation copies and displays digital images. The database server includes image records and patient records. The image records include all user manipulations of the digital image as commands, and recalled digital images are displayed as last viewed.

### CROSS REFERENCE TO RELATED APPLICATIONS

This application claims the benefit under 35 U.S.C. section 119(e) of United States provisional patent application Ser. No. 60/442,609 filed Jan. 23, 2003, pending.

### BACKGROUND OF INVENTION

1. Field of the Invention

The present invention relates to image management and more particularly to a system and method for acquiring, maintaining and displaying digital medical diagnostic images.

2. Background Art

Medical diagnostic imaging relates to x-ray imaging and other forms of examination and diagnosis employing an energy beam to explore the condition of a patient. A variety of other examination methods are in common use, including ultrasound and magnetic resonance. Digital imaging methods have supplemented or replaced certain prior techniques that recorded a medical diagnostic image on a plate or film. A digital image is recorded electronically and displayed on a monitor screen. It is readily possible to convert the digital image to other media, such as a printed picture of the image. In addition, the digital image can be preserved on many types of standard computer storage media, such as a hard drive, tape drive, or optical disc.

Digital x-ray systems offer many advantages over film-based systems. The x-ray dosage is significantly lower. Results are immediate, without the delay of developing film. The ability to manipulate electronic images and share them over a network or in other forms is well recognized as an advantage of electronic media. Consequently, medical diagnostic digital images can be viewed over a local or wide-area network. Images can be processed and reprocessed more readily than with a film-based technology.

As the use of digital imaging becomes wide spread, there is a need to make the advantages of digital technology available at a level that does not require specialized expertise or long schooling. Hospitals and medical clinics often employ specialists in radiology to administer x-ray, CAT scans, MRI scans, and others. However, in many situations, specialists are not often used or not appropriate. For example, in many dental offices, smaller medical offices, and the like, the number of trained medical or dental professionals may be small and the expertise in digital techniques likewise may be limited.

There is a need to create a system that many types of users can operate for improved management and full functionality in manipulating digital images. Such a system should bring the advantages of digital imaging to any level of professional practice, even those employing a single professional. Dental offices stand out as a professional situation in which the patient and a single dentist operate in a one-to-one treatment setting. Although assistants frequently are available, the individual dentist tends to be the cornerstone of the practice and to have the main role in treating and advising the patient. Furthermore, x-rays are a frequent and often necessary part of dental examination and diagnosis. The dentist should have an improved range of tools to more readily and effectively bring the benefits of digital imaging technology to his practice.

It would be desirable to have a medical imaging telemetry device that offers an interactive and intuitive interface. Such a system may offer integrated input/output peripherals. Such a system may be software-based for use with multi-tiered and distributed software networks of mini-computers. Ideally, such a system provides automated storage and retrieval of data in latent real-time. Further, it should offer accessibility to a variety of interactive pointer, annotation, and contrast control devices, including touch-screen.

To achieve the foregoing and other objects and in accordance with the purpose of the present invention, as embodied and broadly described herein, the method and apparatus of this invention may comprise the following.

### SUMMARY OF INVENTION

A radiography image management system includes a file server for storing digital images and a database server for storing metadata; an image spooler, a user workstation, and an archive spooler each connected to the file server and the database server; a digital image capture device connected to the image spooler; and a removable data storage media device connected to the archive spooler. Digital images are captured by the digital image capture device and sent to the image spooler. The image spooler spools digital images to the file server and notifies the database server of each newly captured digital image, and the database server creates an image record for each newly captured digital image. The file server includes all unarchived digital images and the most recently accessed digital images, and sends digital images to the archive spooler, which spools the digital images to the removable data storage media device for storage on removable data storage media. The user workstation includes a display device, an input device, and a graphical user interface. The graphical user interface accesses images records on the database server and copies digital images from the file server for display. The graphical user interface includes user commands for image manipulation, such as enhancement and annotation of the digital images. When a user inputs a command, the result is displayed with the digital image, and the command is recorded in the image record for the digital image. The user commands are tailored for medical diagnosis and to minimize the input steps from the user.

### BRIEF DESCRIPTION OF DRAWINGS

Details of this invention are described in connection with the accompanying drawings that bear similar reference numerals in which:

FIG. 1 is a schematic block diagram of a system embodying the features of the present invention.

FIG. 2 is a schematic block diagram of the system architecture of the system of FIG. 1.

FIG. 3 is a schematic diagram of the software components of the system of FIG. 1.

FIG. 4 is a representative view of a screen display of the system of FIG. 1 with one image panel.

FIG. 5 is a representative view of a screen display of the system of FIG. 1 with one image panel.

FIG. 6 is a representative view of a screen display of the system of FIG. 1 with one image panel.

FIG. 7 is a representative view of a screen display of the system of FIG. 1 with one image panel.

FIG. 8 is a representative view of a screen display of the system of FIG. 1 with two image panels.

FIG. 9 is a representative view of a screen display of the system of FIG. 1 with four image panels.

FIG. 10 is a representative view of a screen display of the system of FIG. 1 with four image panels.

FIG. 11 is a representative view of a screen display of the system of FIG. 1 with twelve image panels.

FIG. 12 is a representative view of a screen display of the system of FIG. 1 with twelve image panels.

FIG. 13 is a representative view of a screen display of the system of FIG. 1 with eighteen image panels.

FIG. 14 is a representative view of a screen display of the system of FIG. 1 with eighteen image panels.

FIG. 15 is a representative view of a screen display of the system of FIG. 1 with twenty-four image panels.

FIG. 16 is a representative view of a screen display of the system of FIG. 1 with a console window.

FIG. 17 is a representative view of a screen display of the system of FIG. 1 with a console window.

FIG. 18 is a representative view of a screen display of the system of FIG. 1 with a console window.

FIG. 19 is a representative view of a screen display of the system of FIG. 1 with a console window.

FIG. 20 is a representative view of a screen display of the system of FIG. 1 with a console window.

FIG. 21 is a representative view of a screen display of the system of FIG. 1 with a console window.

FIG. 23 is a representative view of a screen display of the system of FIG. 1 with a text annotation.

FIG. 24 is a representative view of a screen display of the system of FIG. 1 with annotations.

FIG. 25 is a representative view of a screen display of the point flag control of the system of FIG. 1.

FIG. 26 is a representative view of a screen display of the measure control of the system of FIG. 1.

FIG. 27 is a representative view of a screen display of the ink control of the system of FIG. 1.

FIG. 28 is a representative view of a screen display of the system of FIG. 1 with a zoom box.

FIG. 29 is a representative view of a screen display of the system of FIG. 1 with a resize box.

FIG. 30 is a representative view of a screen display of the system of FIG. 1 with a shrink box.

FIG. 31 is a representative view of a screen display of the system of FIG. 1 with contrast controls including channel button.

FIG. 32 is a representative view of a screen display of the system of FIG. 1 with contrast controls including preset buttons.

### DETAILED DESCRIPTION

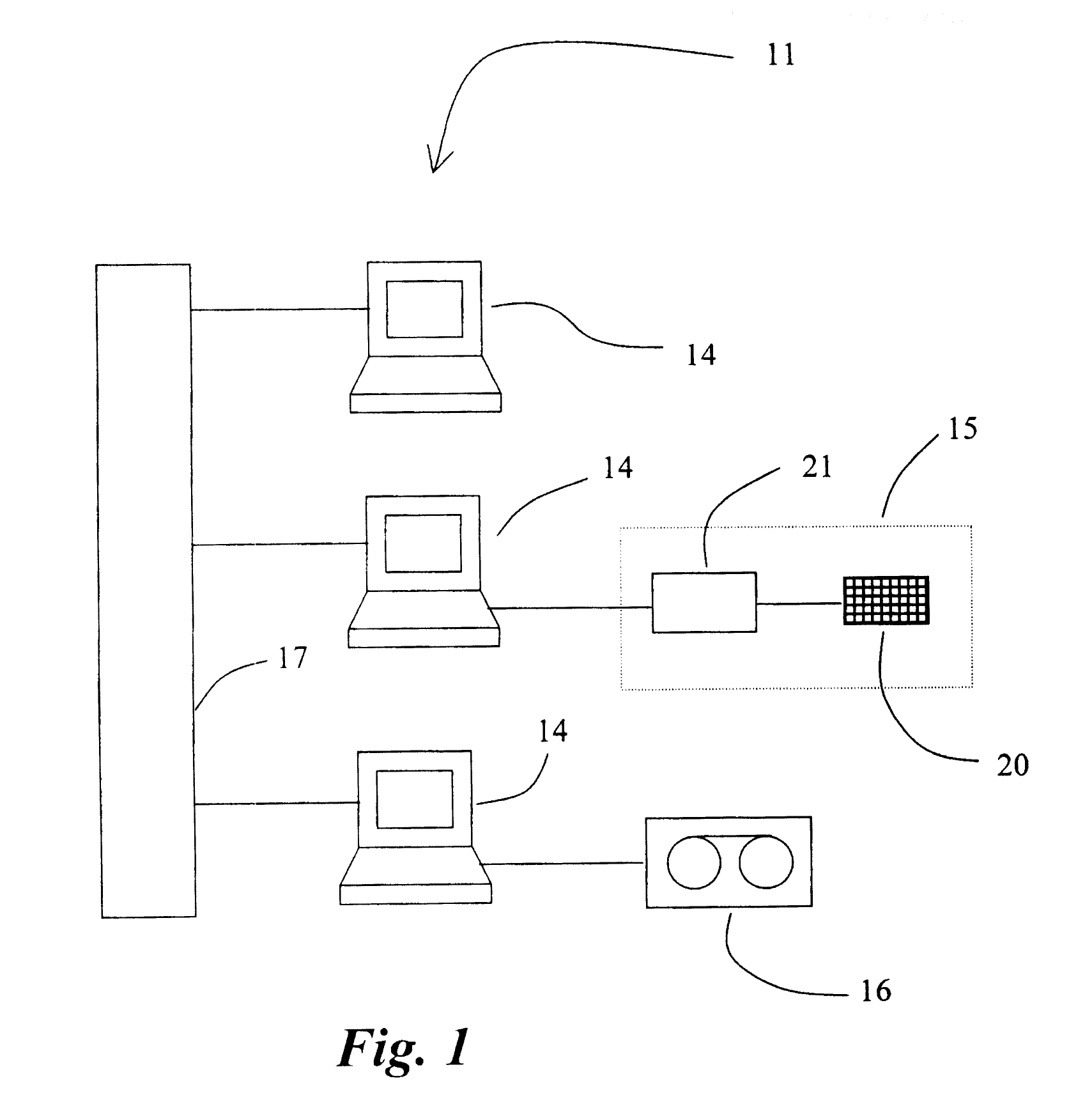

Referring now to FIG. 1, a radiography image management system 11 embodying features of present invention includes at least one computer 14, an image capture device 15 connected to a computer 14, a removable data storage media device 16 connected to a computer 14 and a local area network 17 between a plurality of the computers 14. By way of example, and not as a limitation, the illustrated embodiment is directed towards a system for management of digital dental x-ray images. The image capture device 15 shown has a CCD X-ray sensor 20 connected to a pre-imaging processor 21 that connects to a computer 14 via a universal serial bus (USB) interface. The pre-imaging processor 21 provides power to the sensor 20, digital signal amplification, hardware level control, data transfer, and buffering. The removable data storage media device 16 shown is a tape drive.

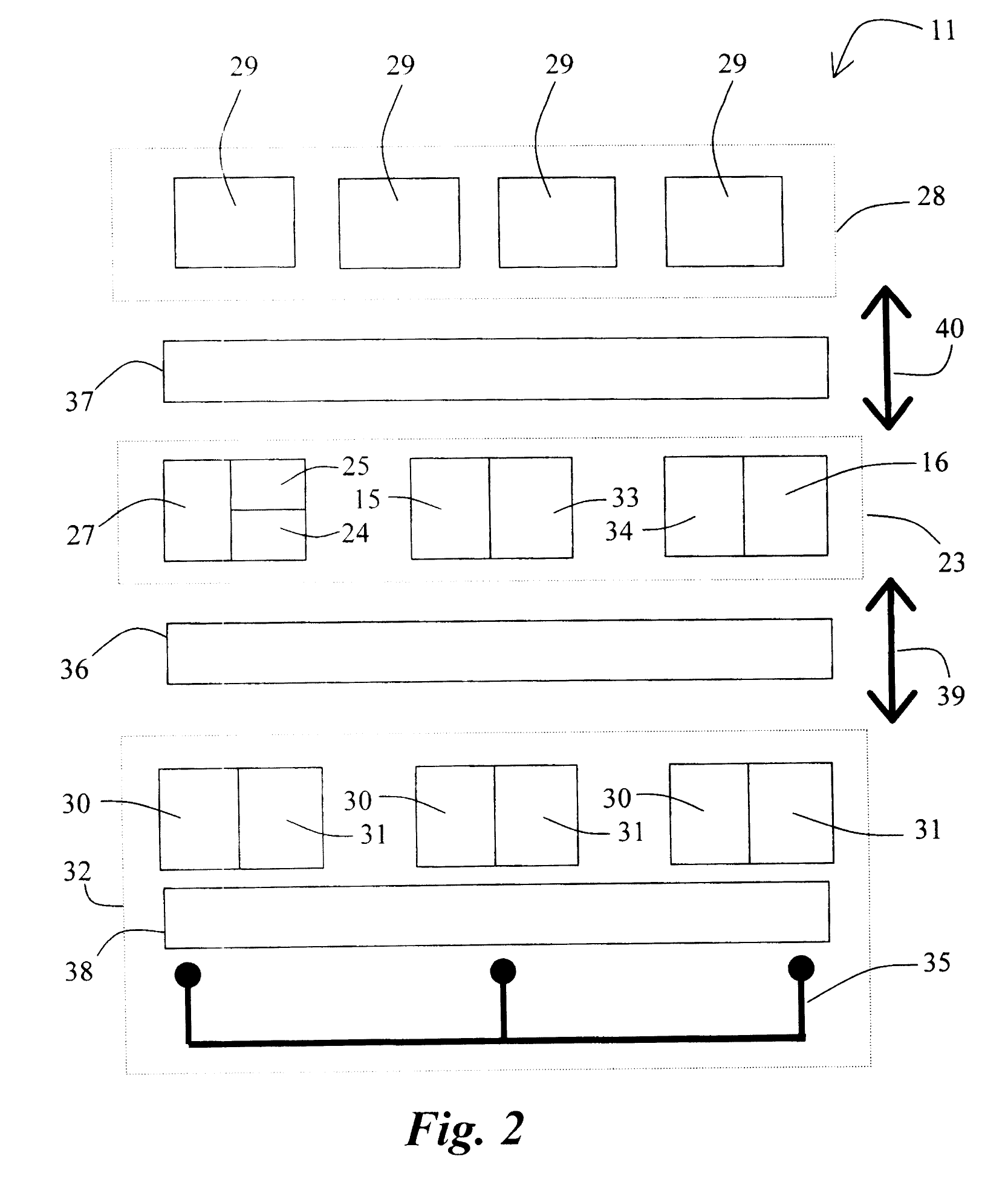

As shown in FIG. 2, the computer 14 includes a workstation 23 with an input device 24 and a display device 25. Preferably the computer 14 is a touch-screen computer in which the input device 24 and the display device 25 are combined. Such touch-screen computers are inherently more aseptic and easy to clean than typical office computers, require only one hand to operate, and are compact enough to allow various setups by the dentist. Other input devices 24 and display devices 25 may be used. For example, other input devices 24 include a keyboard and a pointing device.

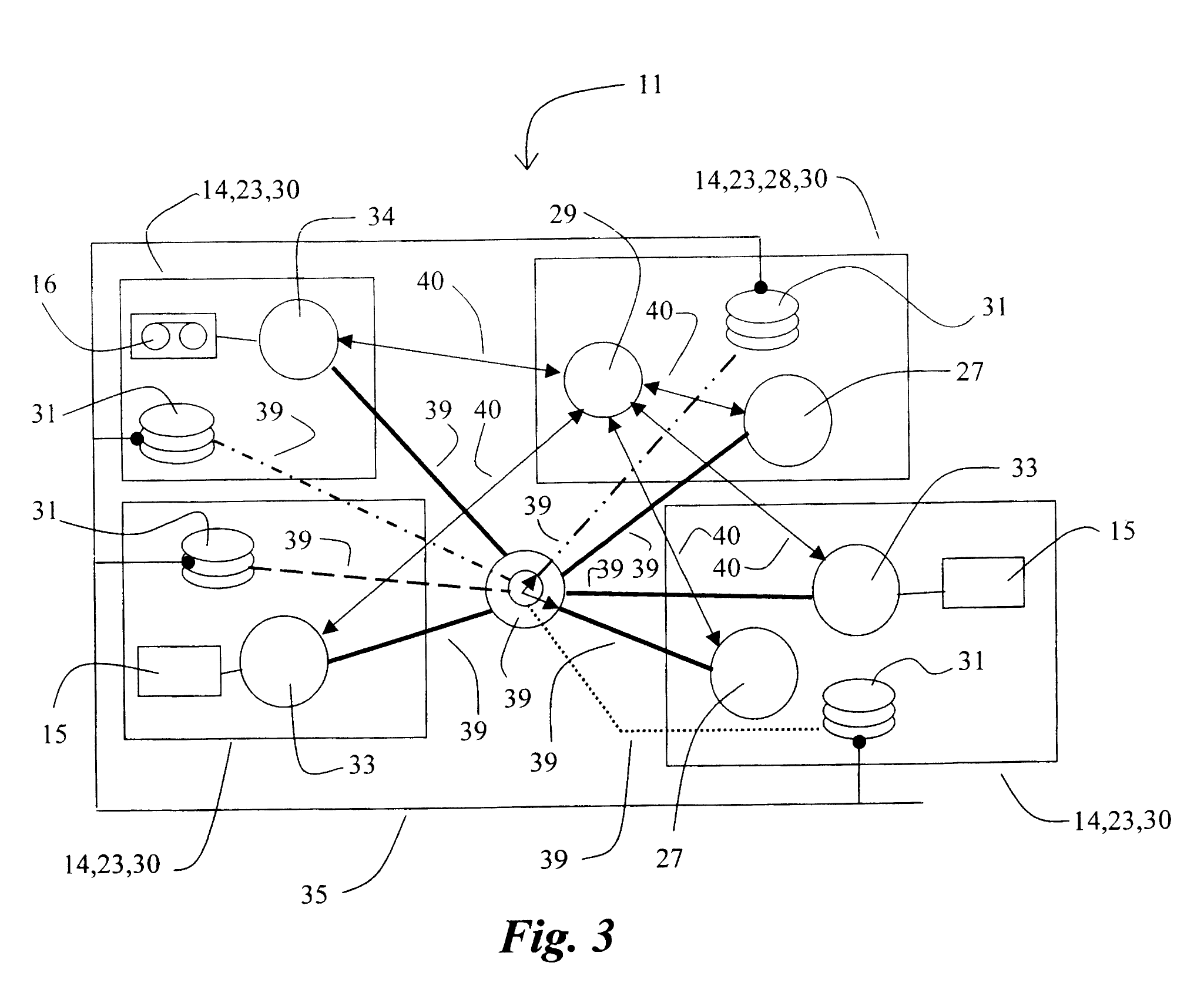

Referring to FIGS. 2 and 3, the radiography image management system 11 includes workstations 23 having graphical user interface 27, a database server 28 in the form of a catalog service 29, a file server 30 made up of a plurality of host services 31 that are combined to form a cloud 32, an image spooler 33, and an archive or backup spooler 34. Workstations 23 and host services 31 communicate over a switched connection 39 using the binary transfer protocol 36. Workstations 23 and the catalog service 29 communicate over a session connection 40 using the message protocol 37. Host services 31 communicate over a routed connection 35 using the workgroup protocol 38.

The image capture device 15 automatically captures a digital image when x-ray radiation is detected and sends the digital image to the image spooler 33. The image spooler 33 sends the digital image to the cloud 32 and notifies the catalog service 29 of the newly captured digital image. The cloud 32 stores all unarchived digital images and the most recently accessed digital images, while maintaining free space for newly acquired images. The cloud 32 sends digital images to the backup spooler 34, which sends the digital images to the removable data storage media device 16 for archiving. Removable data storage media with archived digital images can be stored at a centralized data center and accessed therefrom through a data network.

When the image spooler 33 notifies the catalog service 29 of the newly captured digital image, the catalog service creates a new layered image record including a file identifier, and the date and time of creation. The catalog service 29 also includes a patient record for each patient and a user record for each user. In the illustrated embodiment, the digital images are grouped into series, where a series is the set of all of the digital images for a patient for a single session or day.

The graphical user interface 27 accesses an image record on the catalog service 29 to acquire the identifier for a digital image, copies the digital image from the cloud 32, and displays the digital image. The original image data for each digital image in the cloud 32 never changes. User commands to the graphical user interface 27, described hereinafter, are displayed on the display device 25 and automatically saved to the catalog service 29 in the image record, patient record, or user record.

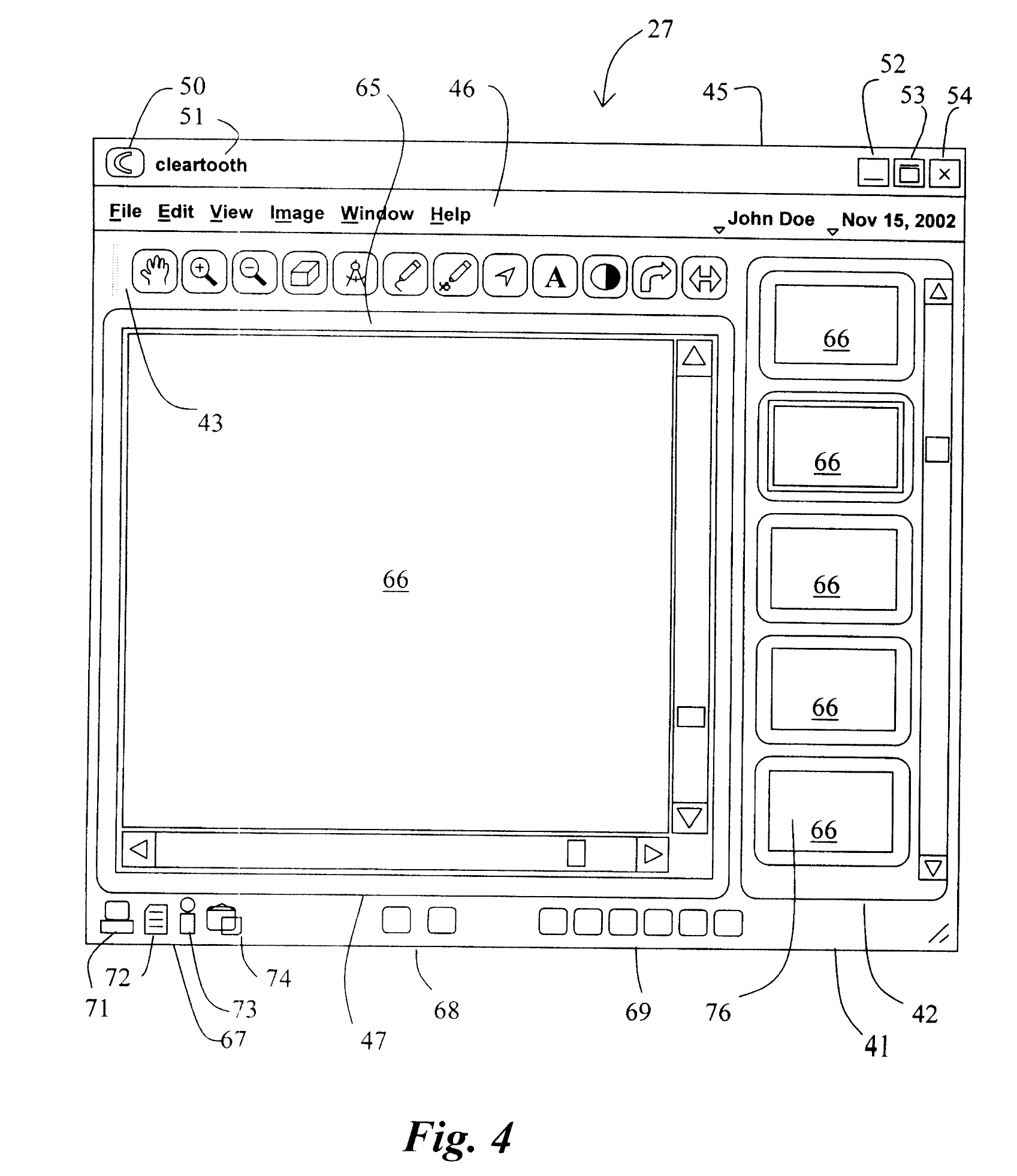

When a user initiates the graphical user interface 27, a login screen is displayed. After the user logs in, the graphical user interface 27 displays on the display device 25, as variously shown in FIGS. 4 to 6, an application window 41, an image button palette 42 and a tear-off tool palette 43. The application window 41 includes a title bar 45 extending horizontally along the top, a menu bar 46 extending horizontally below the title bar 45, an image palette 47 below the menu bar 46 and a control palette 48 extending horizontally along the bottom below the image palette 47. The title bar 45 has a logo 50 at the left, an application title 51 to the right of the logo 50, and buttons performing the functions of minimize 52, maximize 53, and close 54 at the left.

The menu bar 46 includes, from left to right, file 56, edit 57, view 58, image 59, window 60, help 61, and selected patients 62 menu buttons, each having a drop down menu. A current series display 63 appears at the right of the menu bar, wherein a current patient is displayed in the selected patients menu button 62, and the date of the current series is displayed in the current series display 63. Selection of one of the file 56, edit 57, view 58, image 59, window 60, help 61, and selected patients 62 menu buttons displays a corresponding vertical drop-down menu.

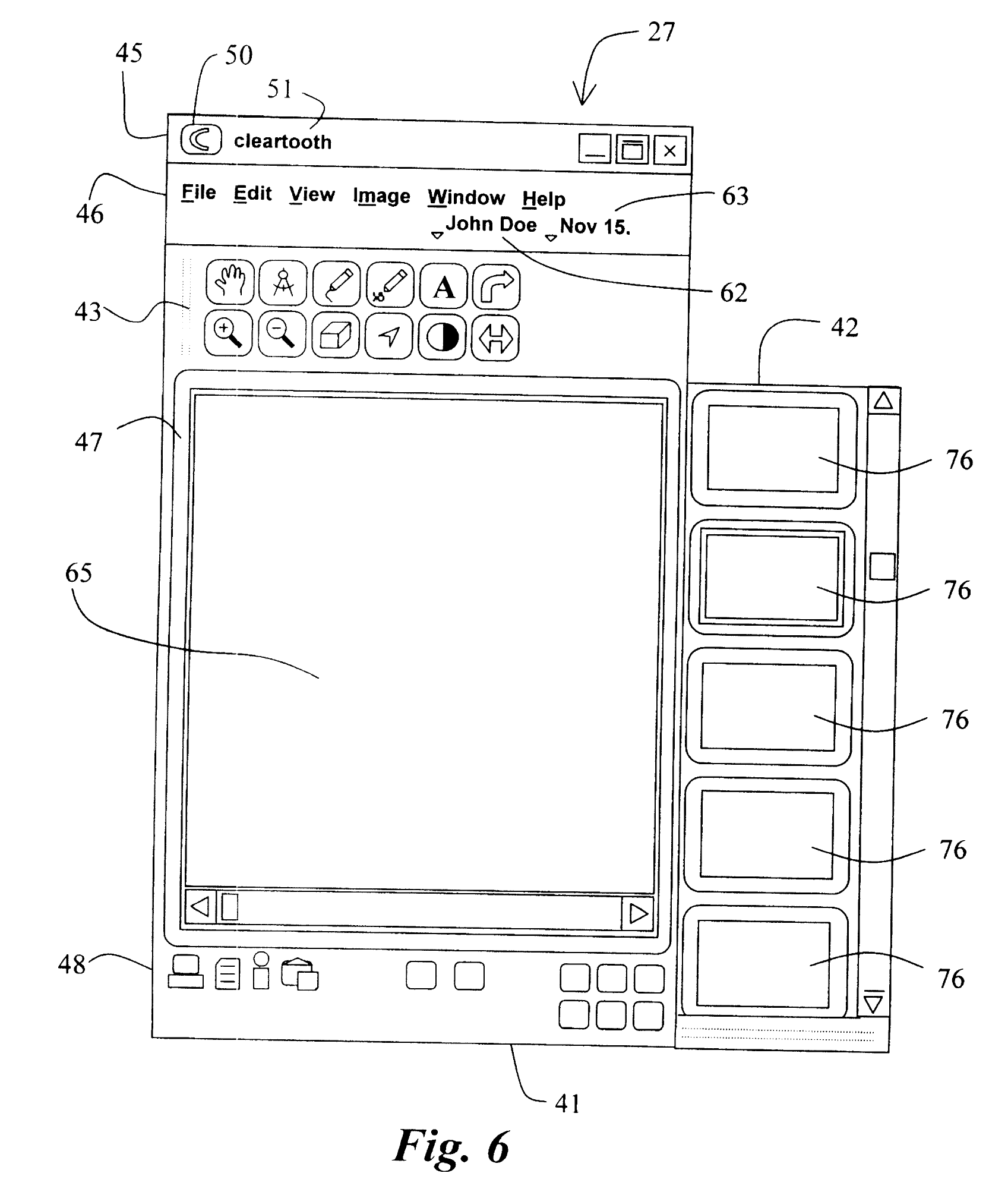

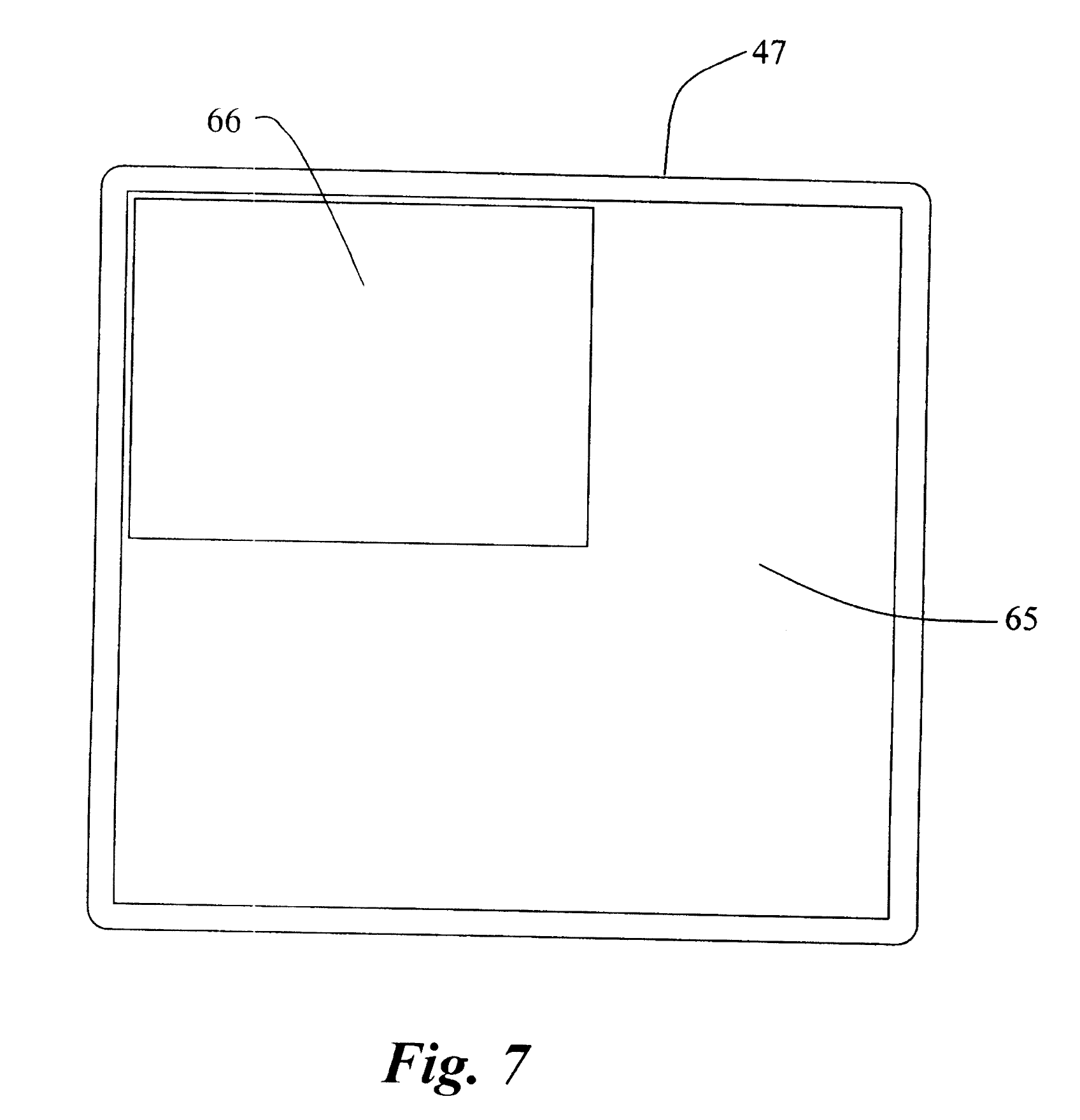

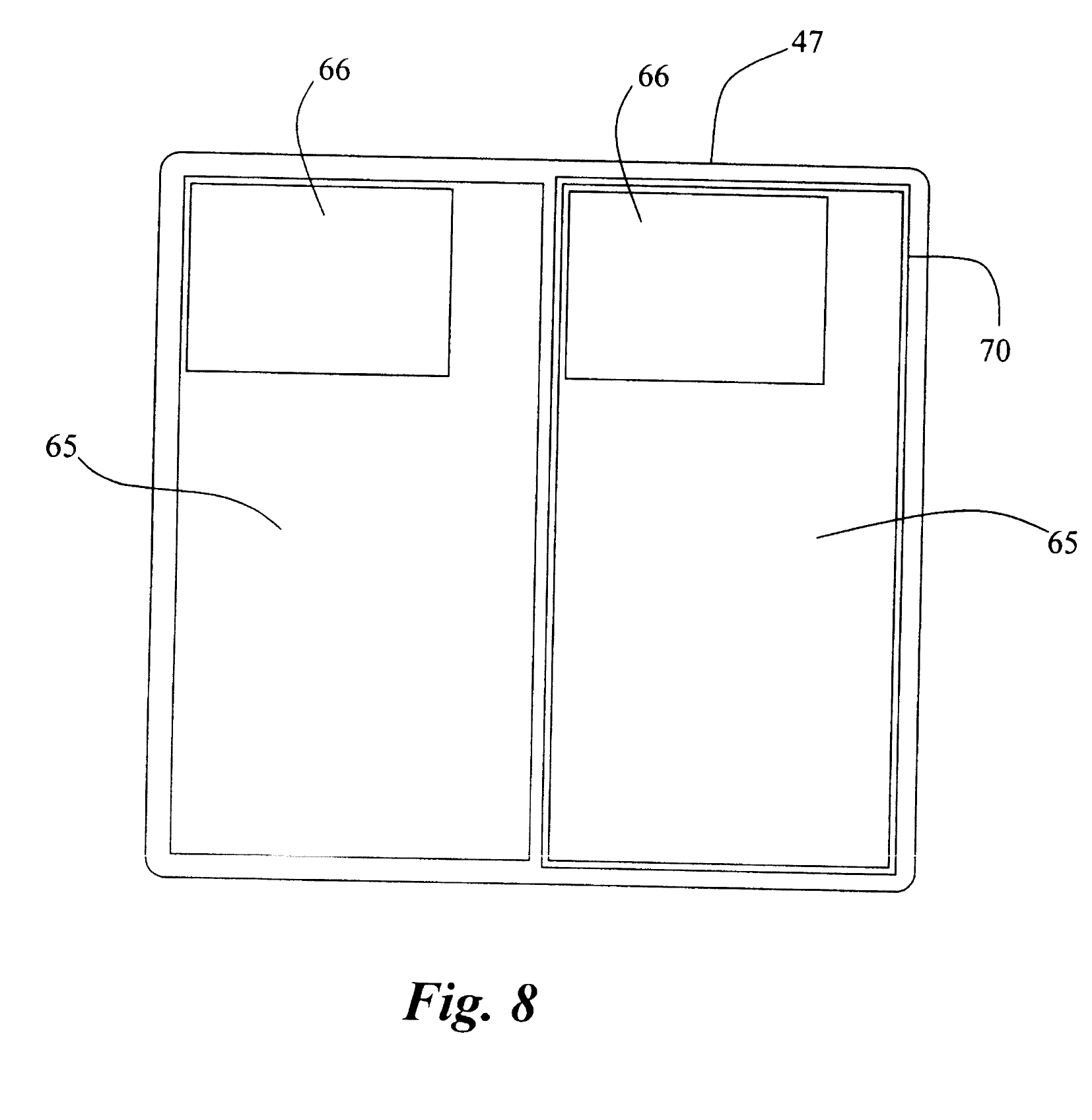

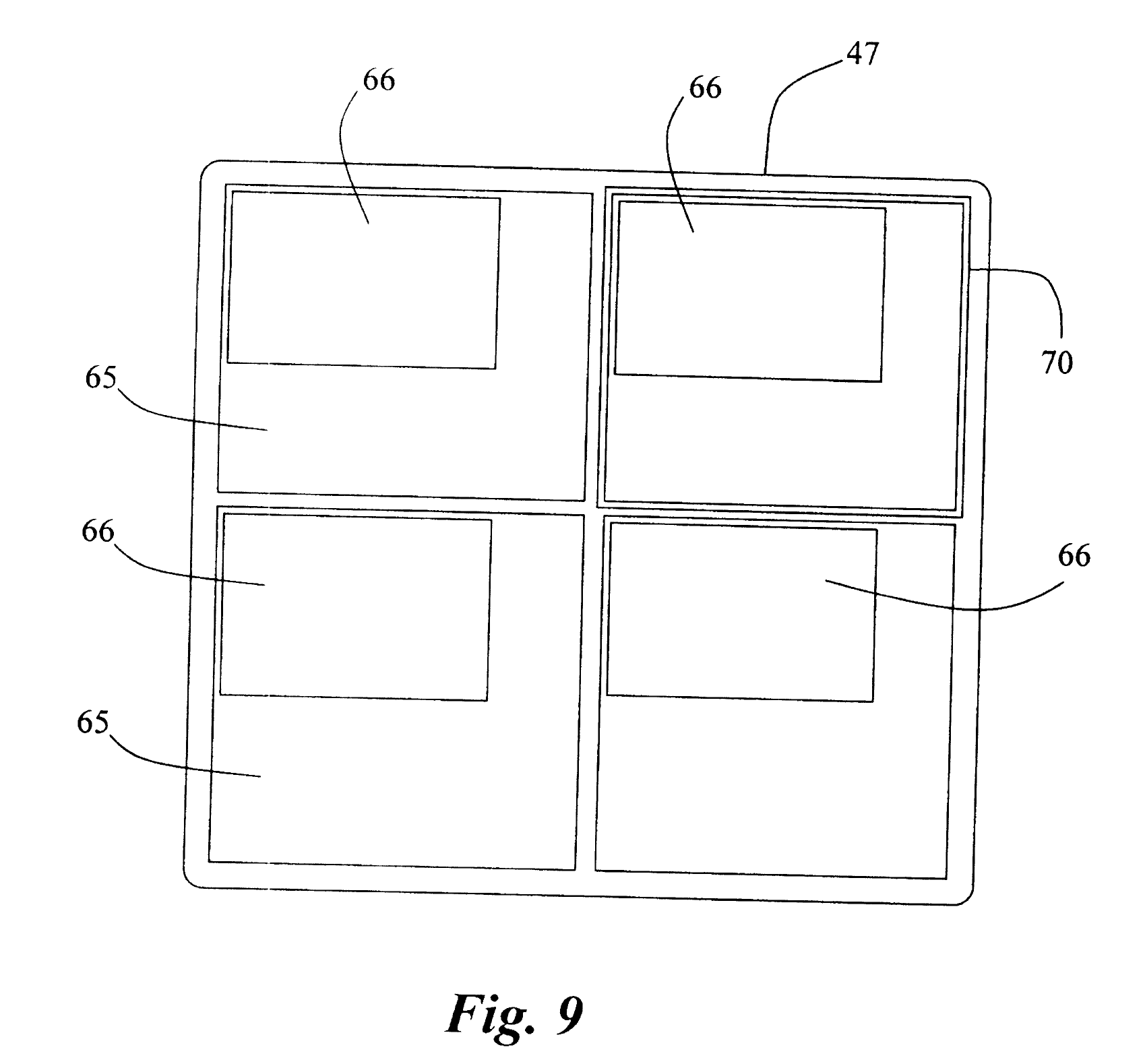

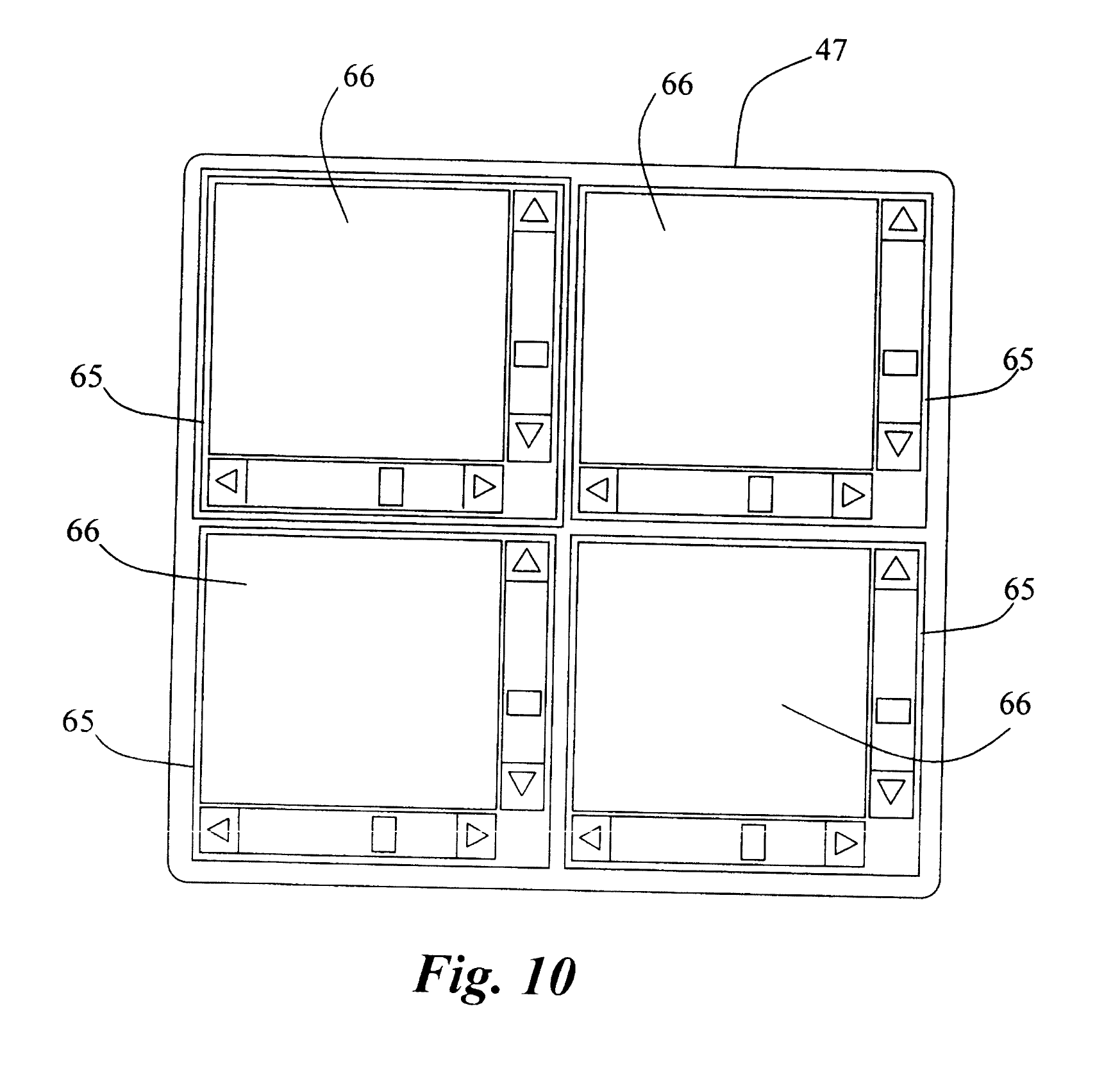

The image palette 47 is the display area and, in the illustrated embodiments variously shown in FIGS. 6-15, displays one, two, four, twelve, eighteen or twenty-four images panels 65 that will each display one digital image 66. Only one image panel 65 is active at any time. The display layouts for one, two or four image panels 65 are defined as table layouts and the display layouts for twelve or eighteen and twenty-four or more image panels 65 are defined as series layouts. FIGS. 4 to 7 show a display layout with one image panel 65. FIG. 8 shows a display layout with two side-by-side image panels 65. The right image panel 65 is active and is indicated by a current image indicator 70. FIGS. 9 and 10 show a display layout with four image panels 65 arranged two across by two down with an active image indicator 70.

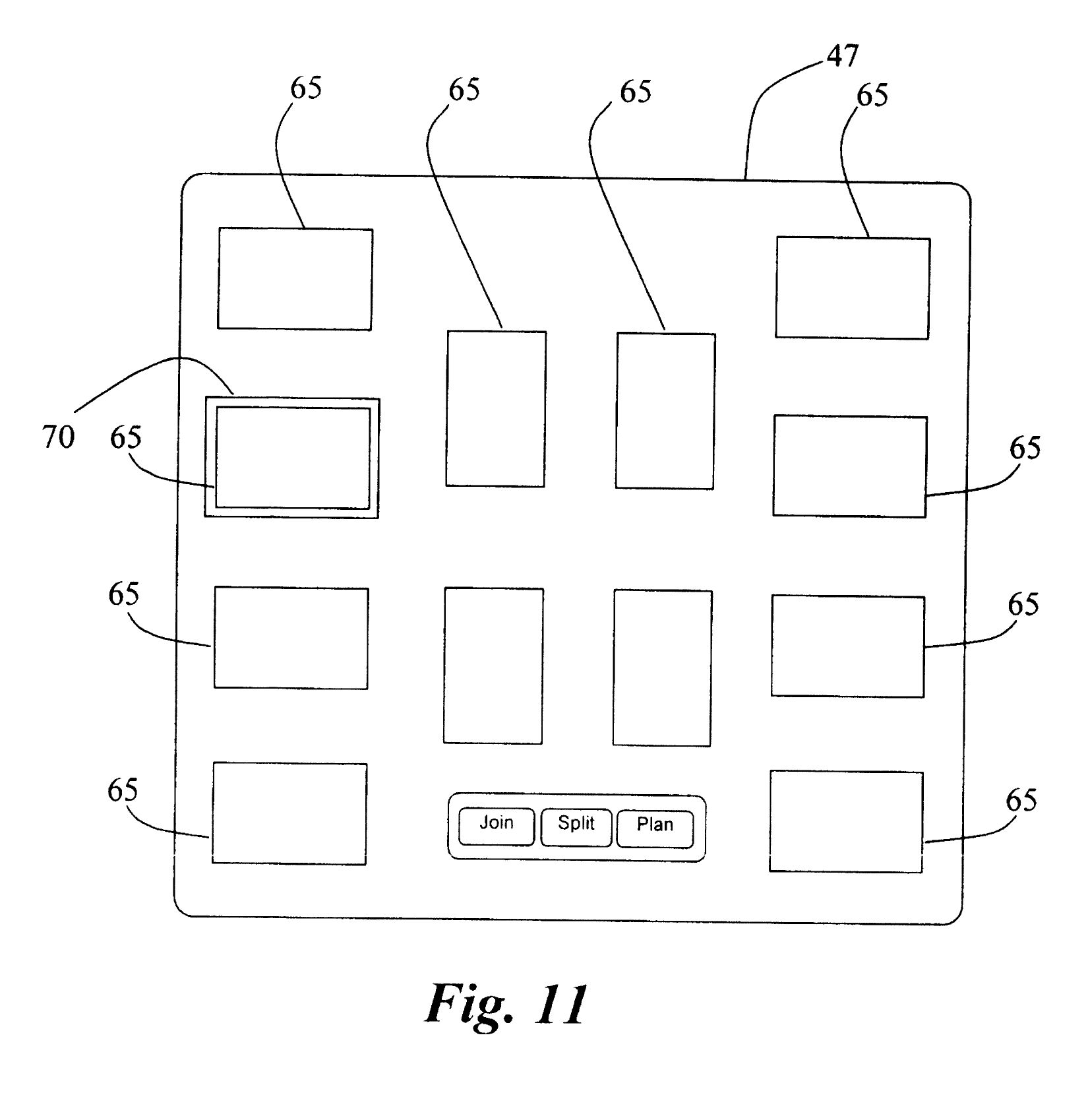

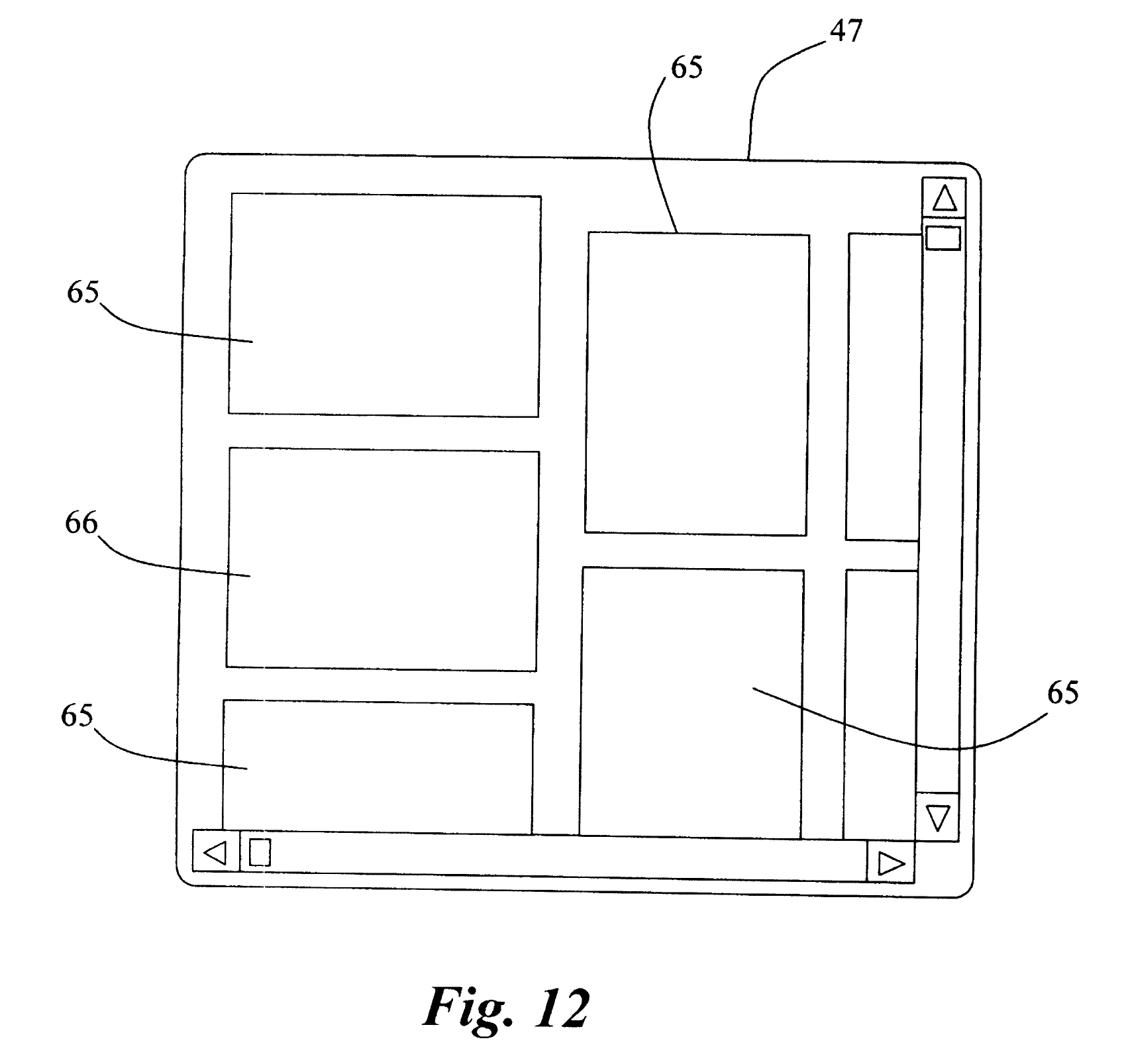

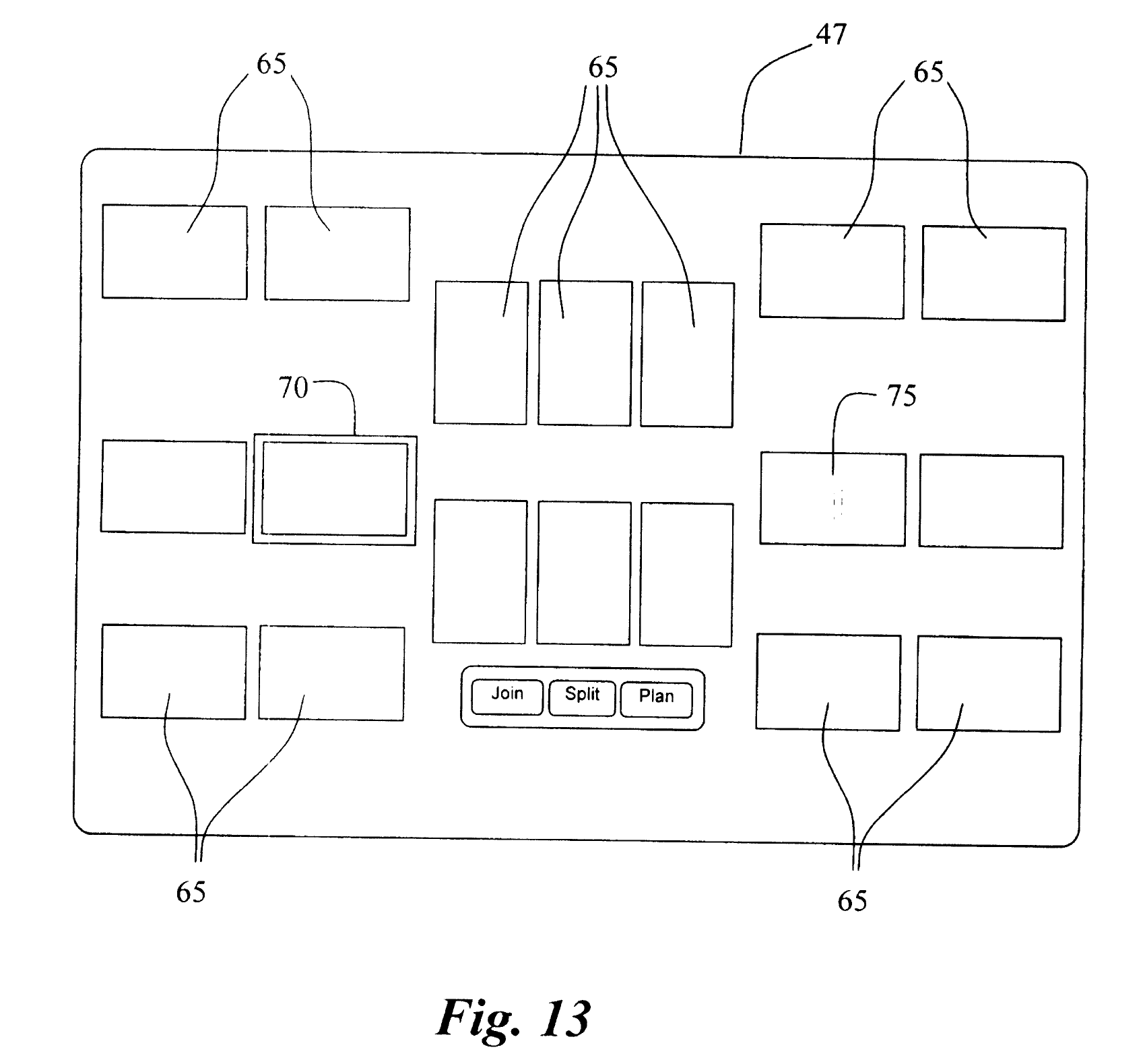

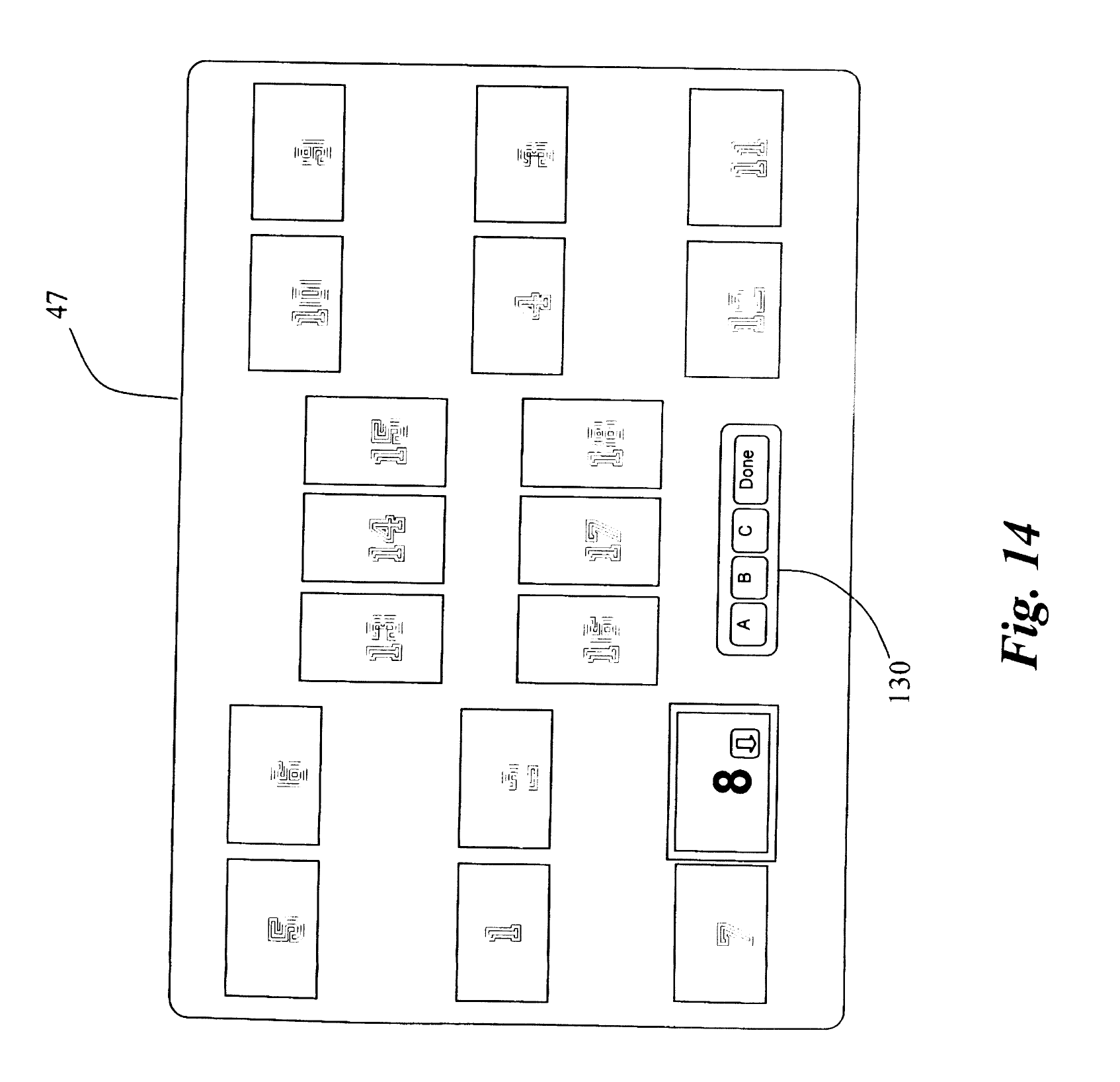

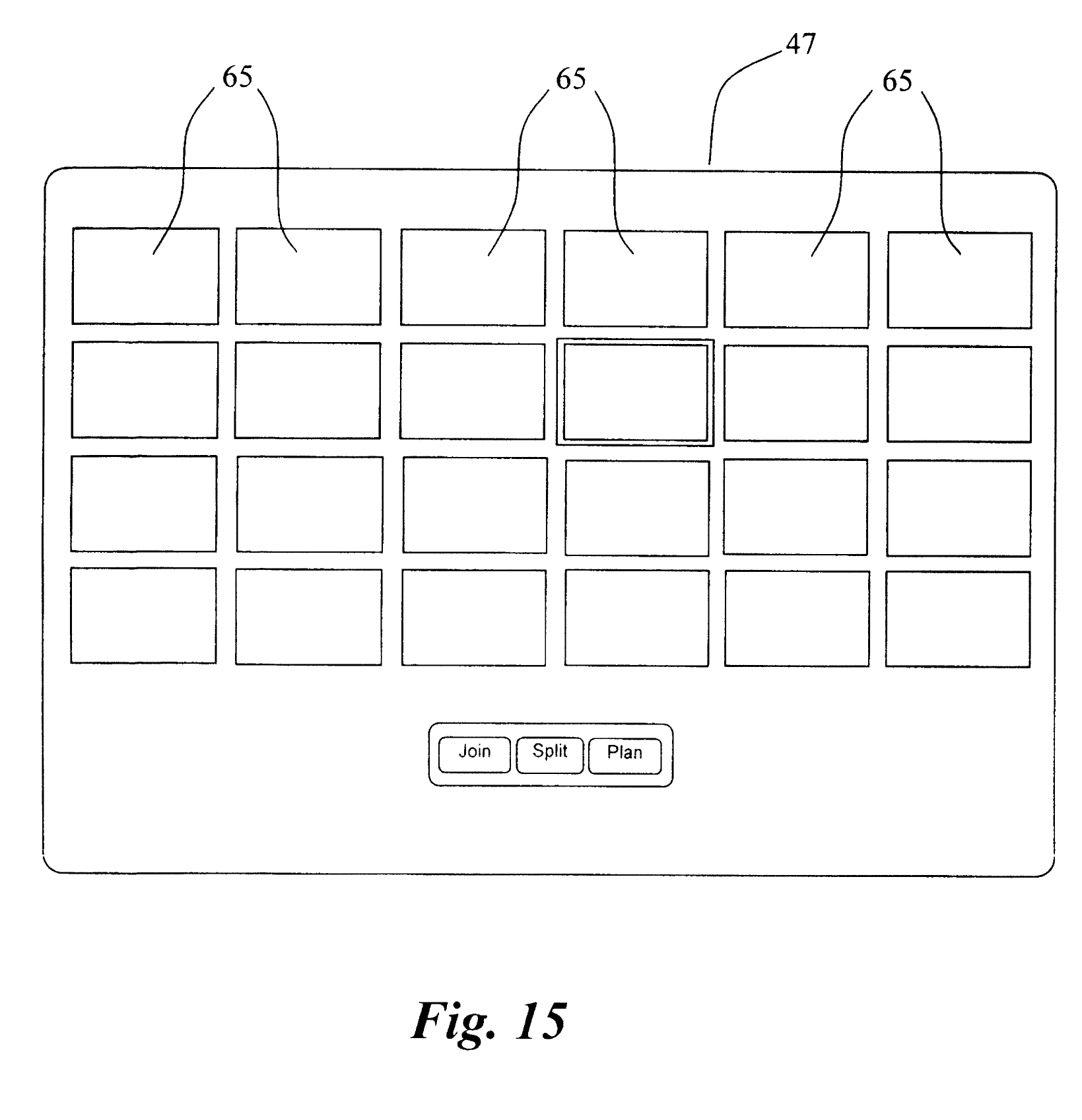

FIGS. 11 and 12 show a display layout with twelve image panels 65 including four vertically spaced, horizontal rectangular image panels 65 along the left side, four vertically spaced, horizontal rectangular image panels 65 along the right side, and four spaced, vertical rectangular image panels 65 in a two by two arrangement in the middle of the image palette 47. FIG. 13 shows a display layout with eighteen image panels 65 including six spaced, horizontal rectangular image panels 65 in a three by two arrangement along the left side, six spaced, horizontal rectangular image panels 65 in a three by two arrangement along the right side, and six spaced, vertical rectangular image panels 65 in a two by three arrangement in the middle of the image palette 47. Other display layouts are displayed, depending on the height and width of the image palette 47. FIG. 14 shows a display layout with eighteen image panels 65 and plan control 130. FIG. 15 shows a display layout with twenty-four image panels 65.

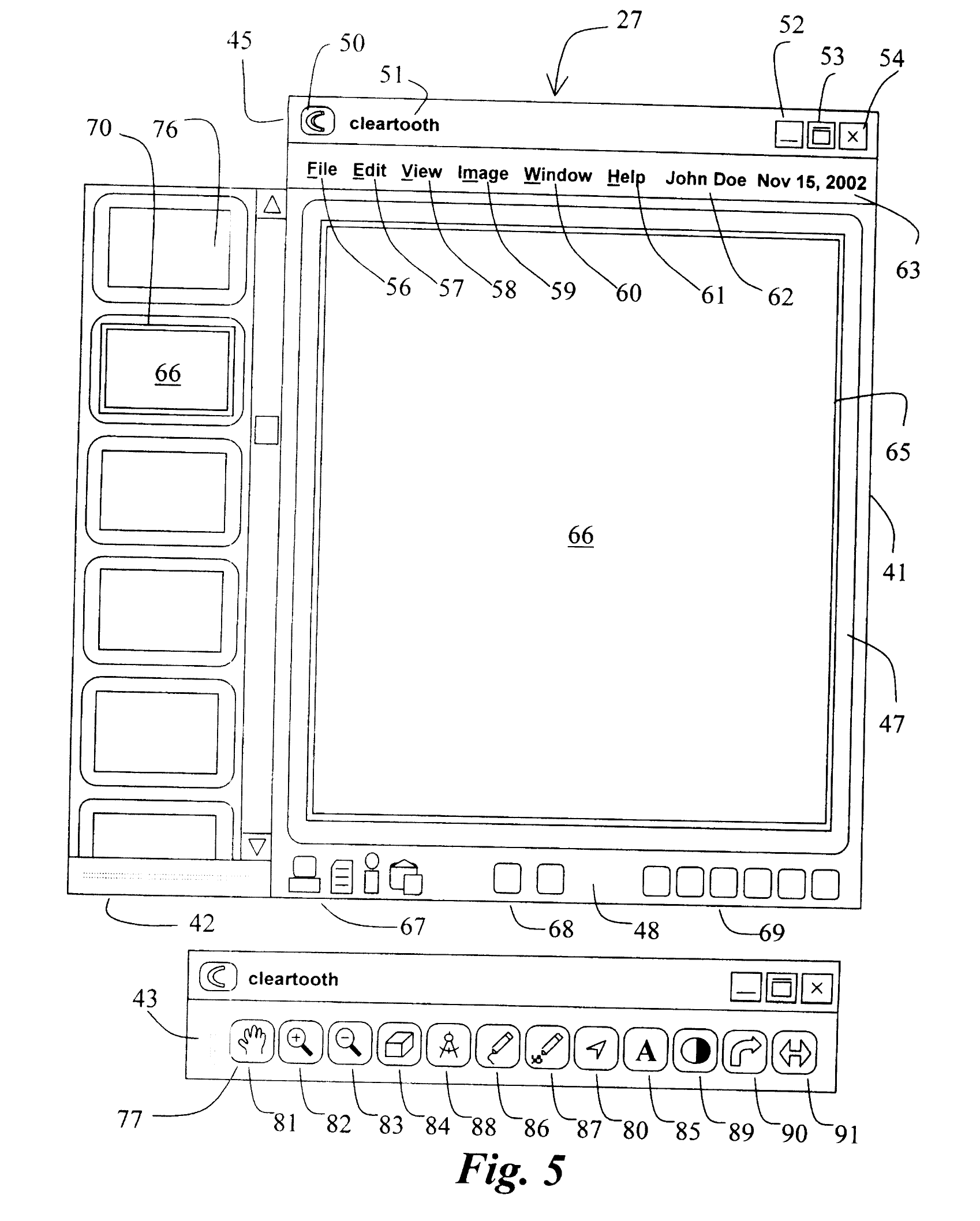

Referring again to FIGS. 4 to 6, the control palette 48 includes, from left to right, an array of console control buttons 67, an array of view control buttons 68, and an array of layout control buttons 69. The console control buttons 67 include a console button 71, a notes button 72, a patient information button 73 and a clipboard button 74. The layout control buttons 69 correspond to the six available display layouts. The view control buttons 68 control magnification of the digital images. The number of view control buttons 68 depends upon the display layout. In the series layouts the view control buttons 68 include “1×” and “2×”. For the table layouts the view control buttons include “100%” and “match.” The image button palette 42 is a scrollable list of thumbnail images of the digital images of a series with each thumbnail image being a selectable image button 76. The default position of the image button palette 42, as shown in FIG. 4, is outside and anchored along the right edge of the application window 41. Alternative positions of the image button palette 42 are outside and anchored along the left edge of the application window 41, as shown in FIG. 5, or inside and anchored along the right edge of the application window 41, as shown in FIG. 6. The graphical user interface 27 positions the image button palette 42 based on the size of the application window 41. The user selects image buttons 76 for display of the respective digital images in the images panels 65 of the image palette 47.

The tear-off tool palette 43 includes twelve tool buttons 77. The position of the tear-off tool palette 43 is user selectable, and can be inside the application window 41, as shown in FIG. 4, or outside the application window 41 as a stand alone window, as shown in FIG. 5, or anchored to the edge of the application window 41, as shown in FIG. 6. When the tear-off tool palette 43 is inside the application window 41, the tear-off tool palette 43 can be horizontally extending above, as shown in FIG. 4, or below the image palette 47, or vertically extending to the right or left of the image palette 47.

When the tear-off tool palette 43 is inside or anchored to the application window 41, the graphical user interface 27 displays the tear-off tool palette 43 in one of six configurations depending on the size of the application window 41 and the position selected for the tear-off tool palette 43. The six configurations of the tear-off tool palette 43 include 1×12, 2×6, 3×4, 4×3, 6×2, and 12×1. The tool buttons 77 include point flag 80, move 81, zoom in 82, zoom out 83, erase 84, text 85, ink 86, highlight 87, measure 88, contrast 89, orient 90, and image button palette on/off 91 buttons. In each configuration of the tear-off tool palette 43, tool buttons 77 with similar functions are displayed in adjacent positions, preferably side by side. For example, the zoom in 82 and zoom out 83 buttons are always adjacent, the point flag 80 and move buttons 81 are always adjacent, and the ink 86 and highlight 87 buttons are always adjacent.

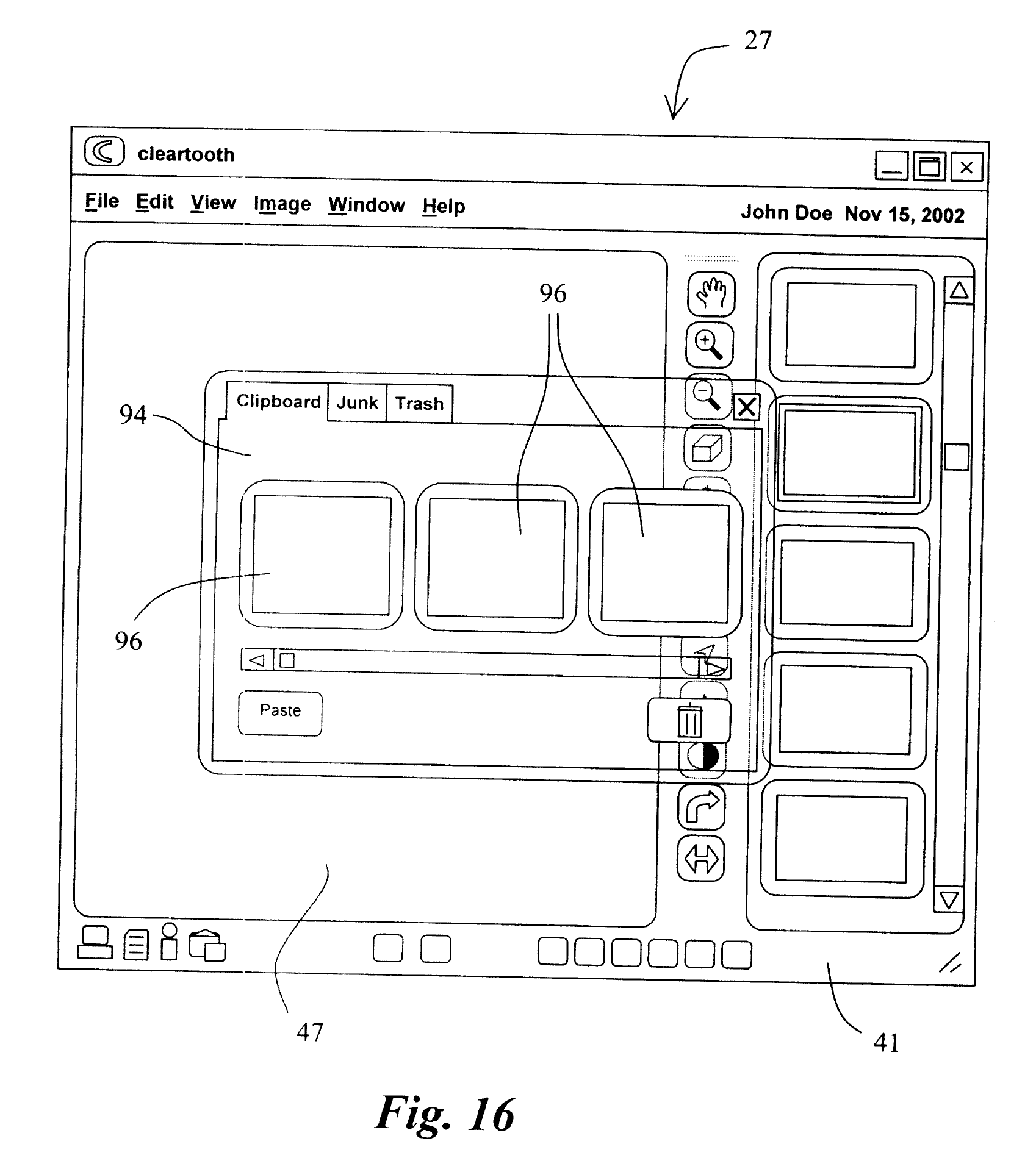

As shown in FIG. 16, the graphical user interface 27 displays a console window 94 in the form of a floating window with a semi-transparent background centered over the center of the application window 41. Console windows 94 include clipboard, notes, find patient and patient information, displayed in response to selection of the console button 71, a notes button 72, a patient information button 73 and a clipboard button 74, respectively. A find patient console window is displayed in response to selection of “open” in the file menu or “find” in the edit menu. The application window 41 remains active while a console window is active and displayed.

When a user logs off, the current configuration is recorded in the user record for the user. When the user logs in again, the graphical user interface 27 displays the prior configuration of the application window 41, the image button palette 42 and the tear-off tool palette 43, including the prior patient and series. The user can select another recently accessed patient and series by selecting the selected patients menu button 62 and then selecting the name from the drop down menu, or the user can select another patient and series by activating the find patient console window.

Selecting the clipboard button 74 activates the clipboard, and the graphical user interface 27 displays the console window 94 for the clipboard. The clipboard includes thumbnail images of all digital images that are not associated with a patient with each thumbnail image being a clipboard image button 96. The user selects the thumbnail image of an unassociated digital image into the image palette 47 and clicks paste to associate the digital image with the current patient and series, and the graphical user interface 27 records the patient and series into the image record for the digital image.

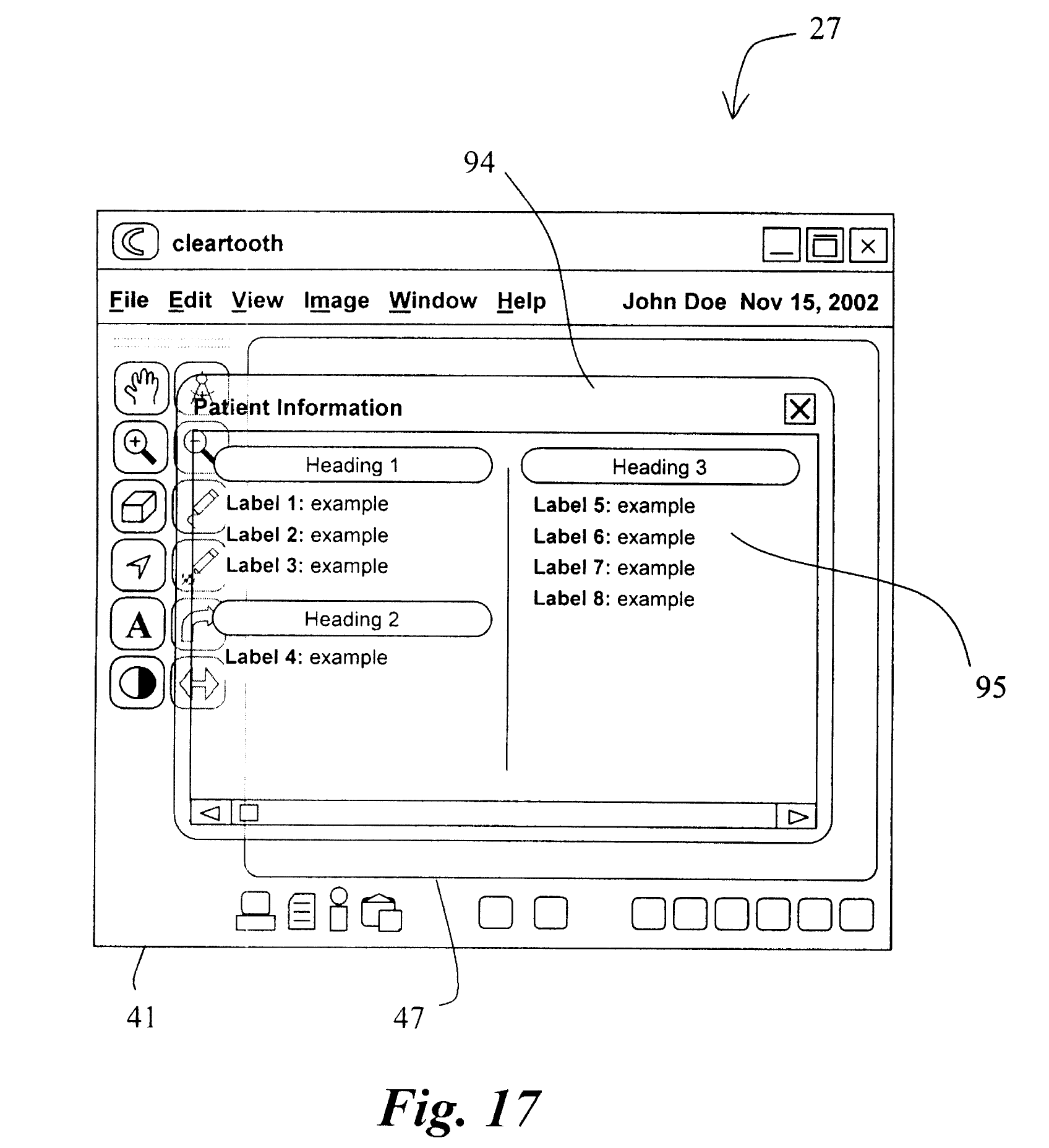

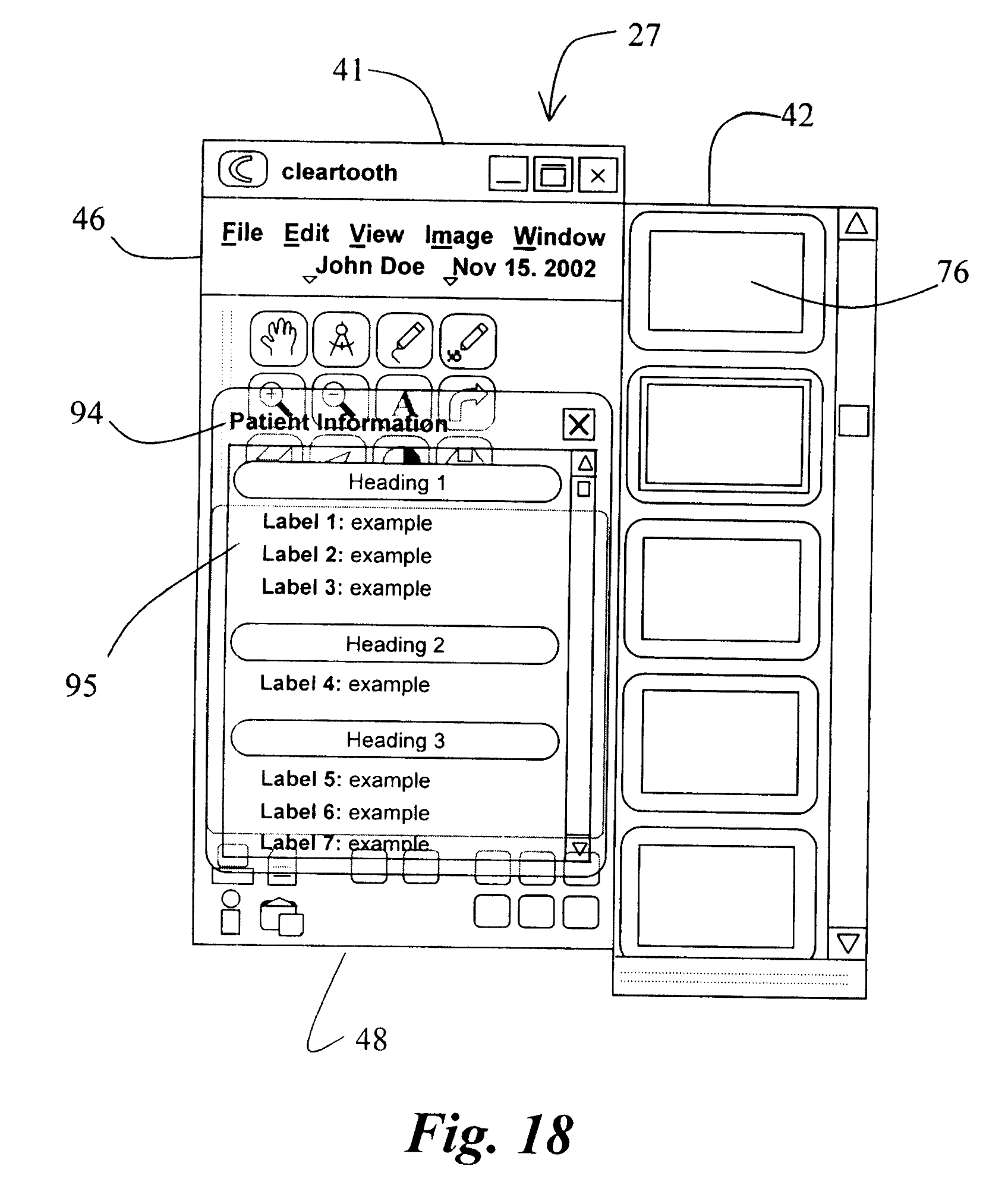

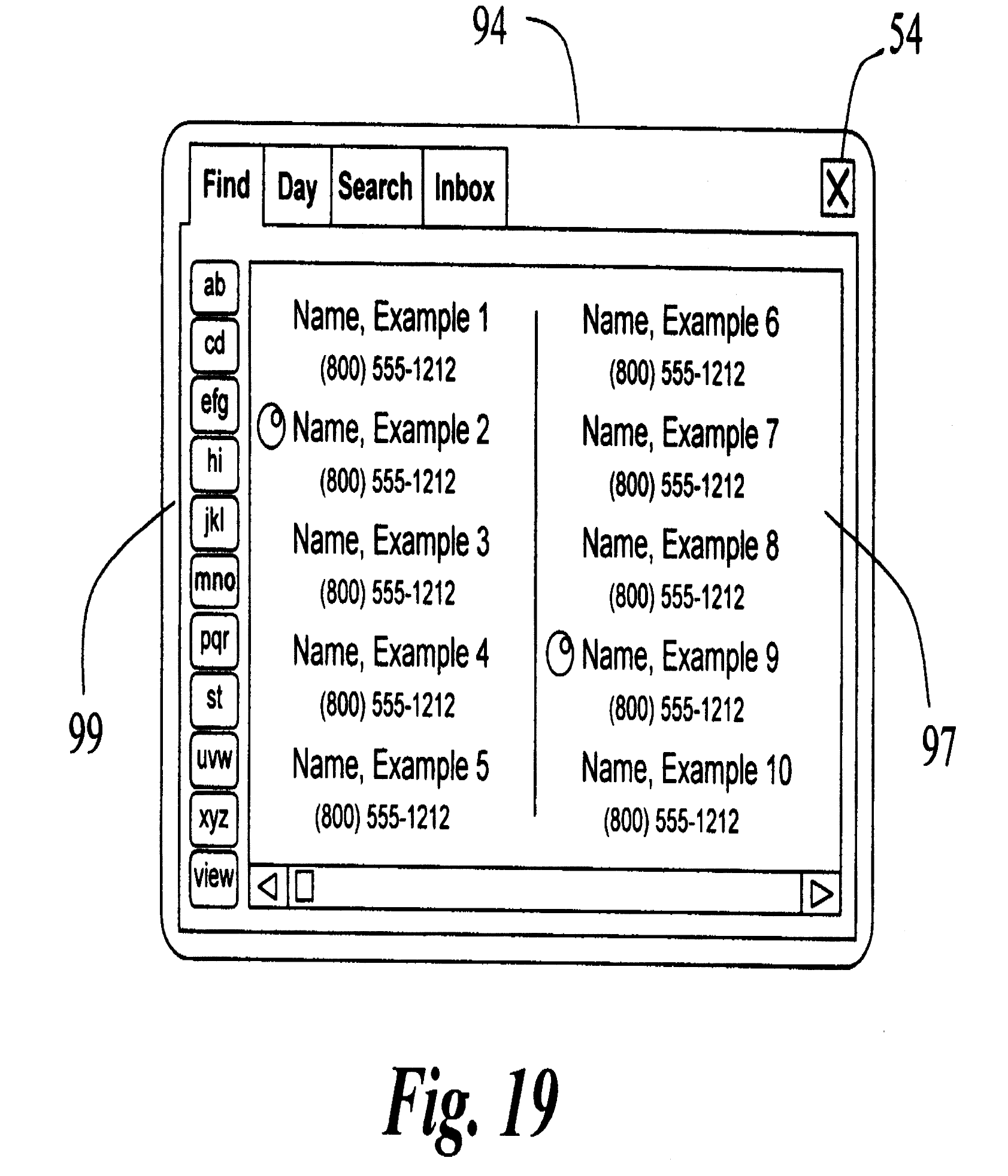

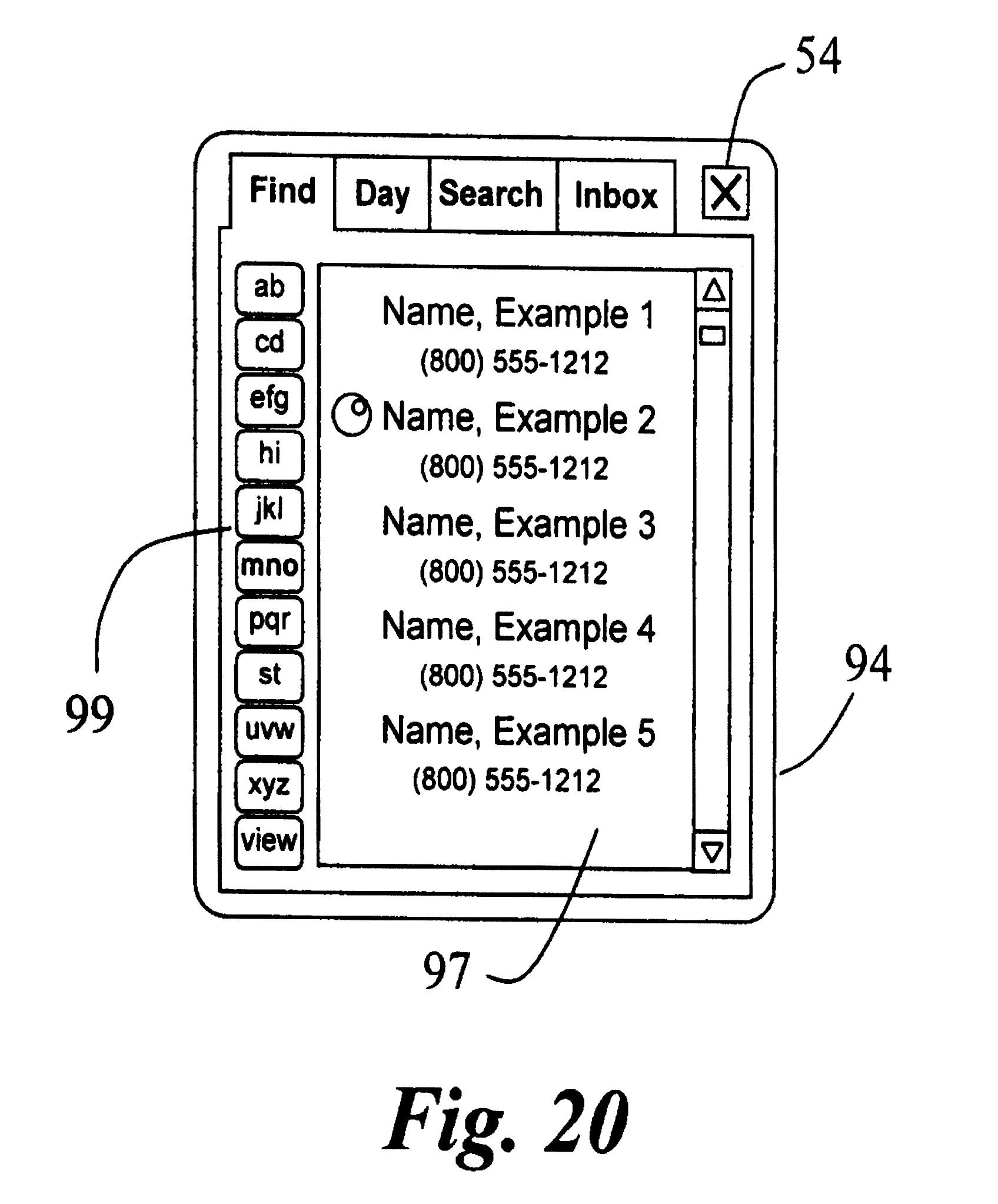

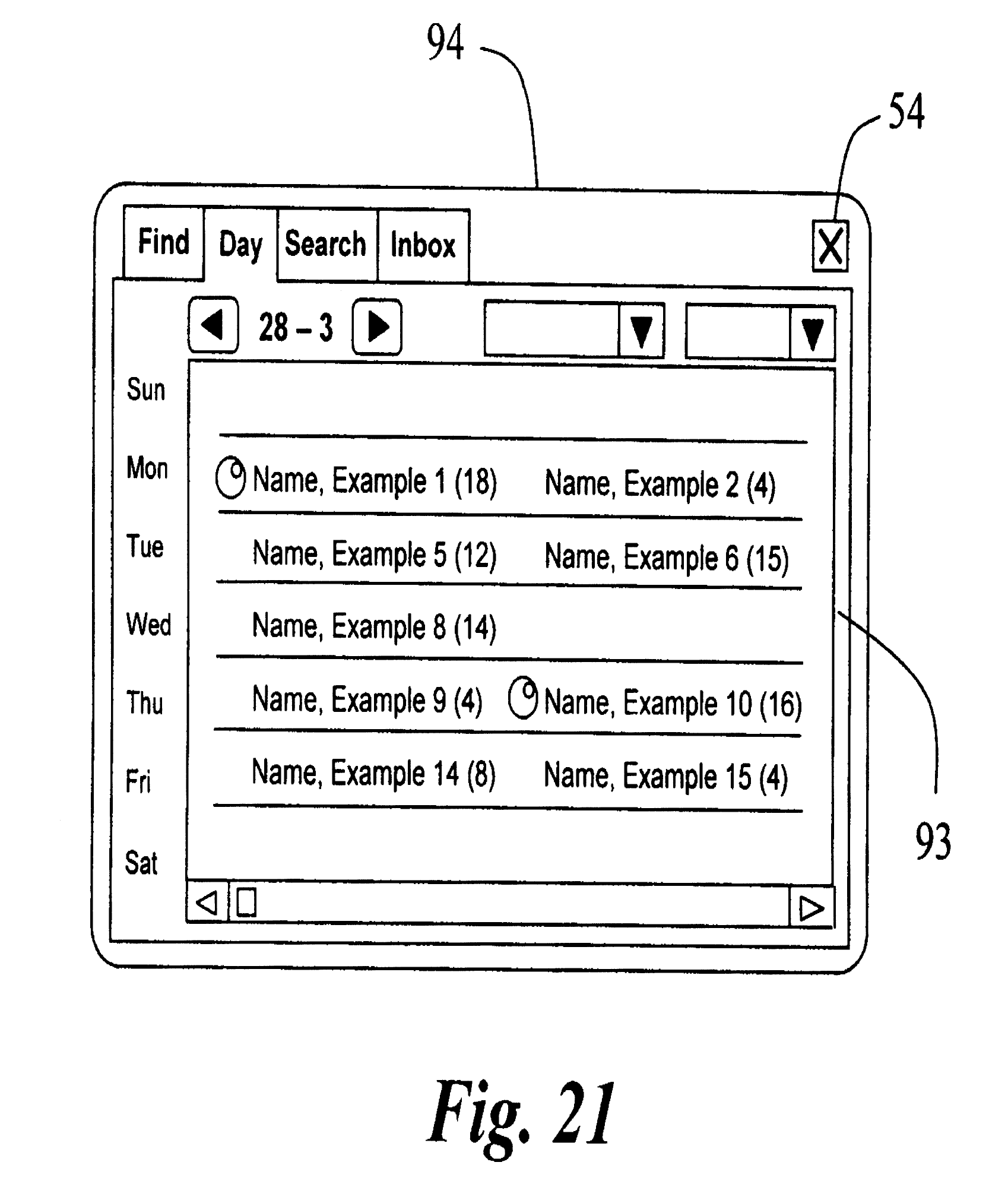

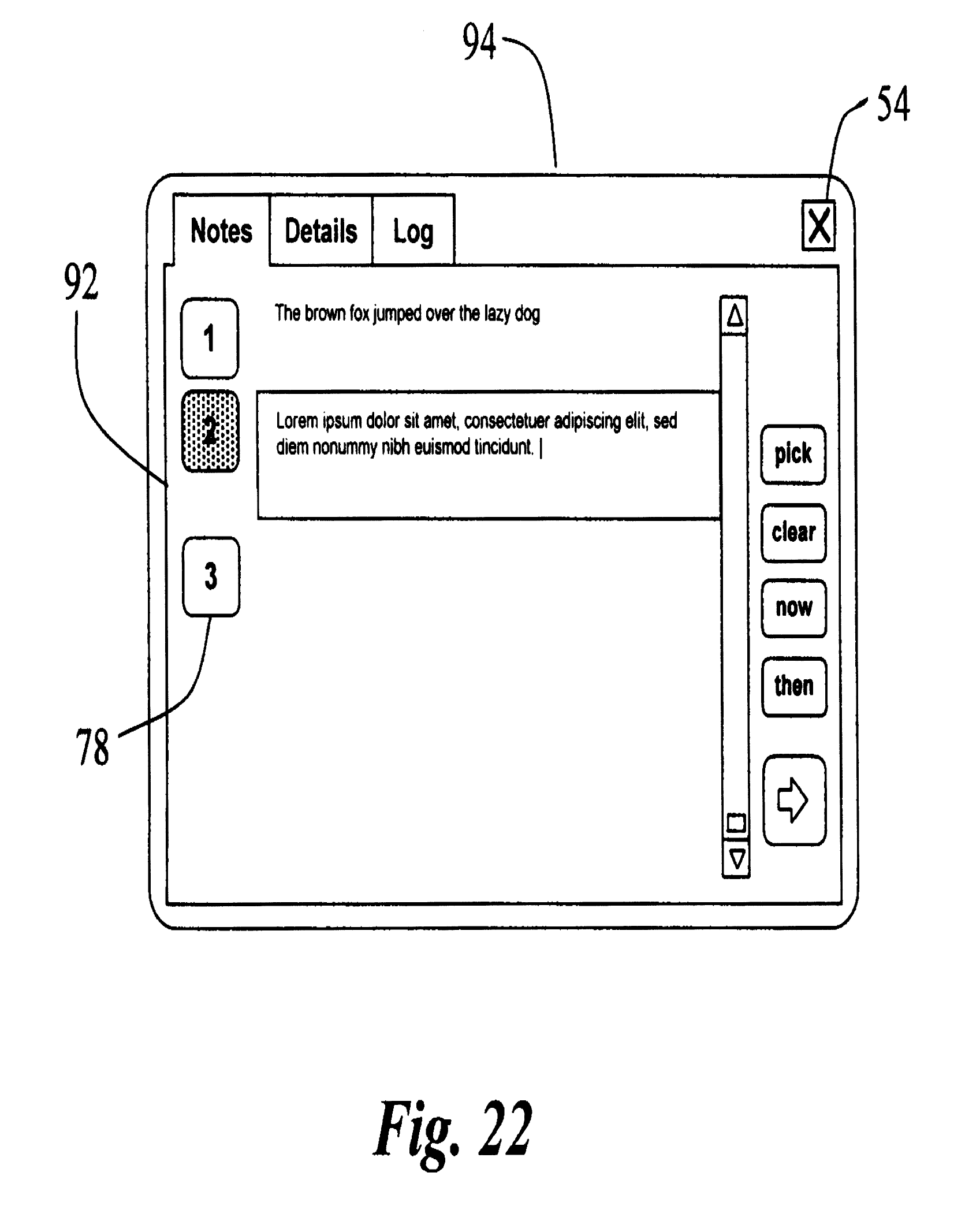

Selecting the patient information button 73 activates the patient information console window, which includes the patient directory 97 or patient log 93. The user clicks on a patient name to select the current patient. Selecting the current patient name displays the current patient information in the console window. The patient directory 97 can be viewed alphabetically by clicking on the patient index control 99. FIGS. 19 and 20 show the console window 94, patient directory 97, patient index control 99 and close button 54. The patient log can be viewed chronologically by clicking the forward and back arrows, entering a date or using the scrollbar in the console window. FIG. 21 shows a console window 94 with patient log 93. User may input or modify patient information 95 by clicking on a line of text in the console window 94 as shown in FIGS. 17 and 18.

Selecting the notes button 72 activates the notes console window which includes image notes 92. The image notes for the active image panel are shown. The user may input new notes or modify existing notes by clicking on the note number button 78 as shown in FIG. 22.

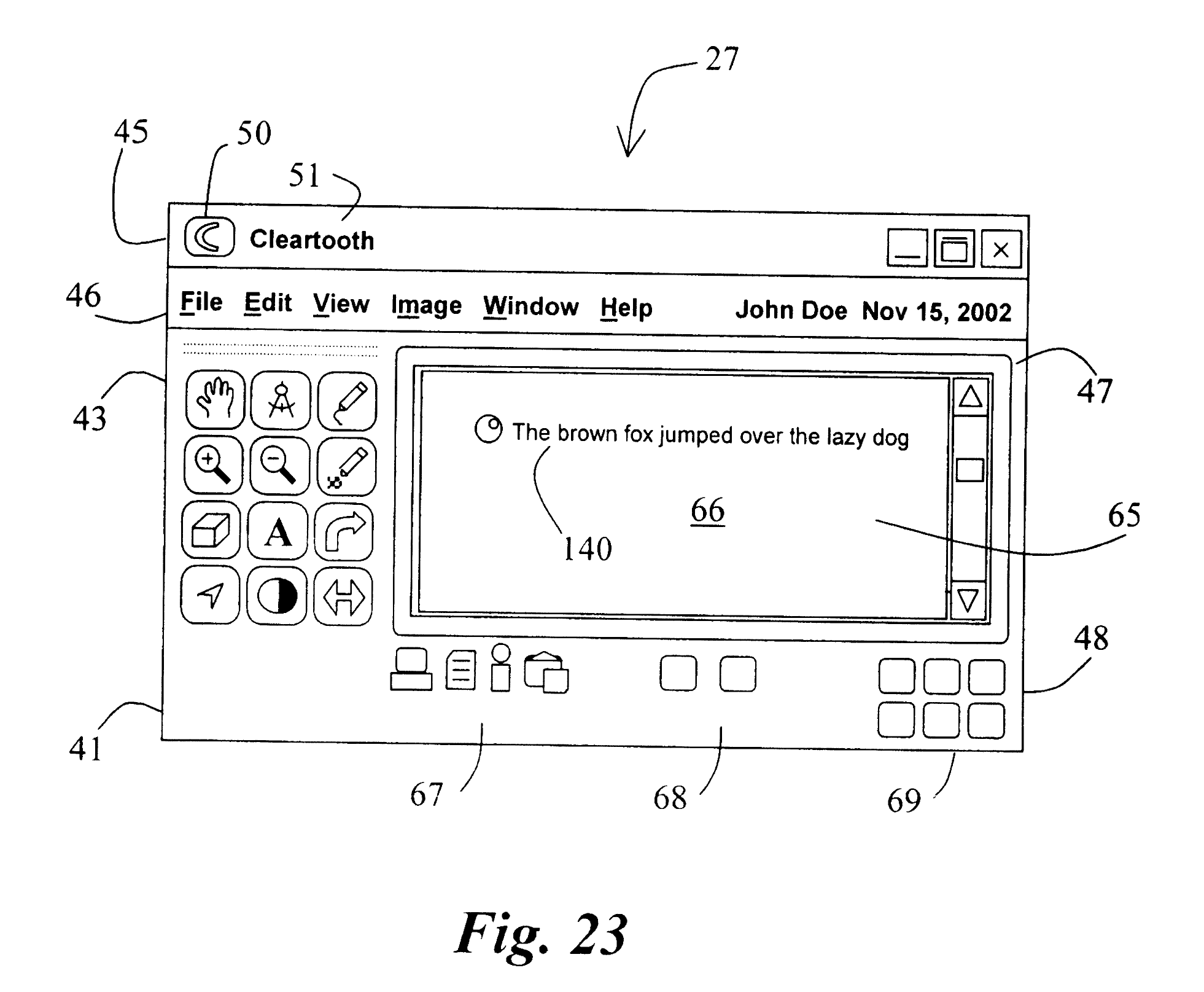

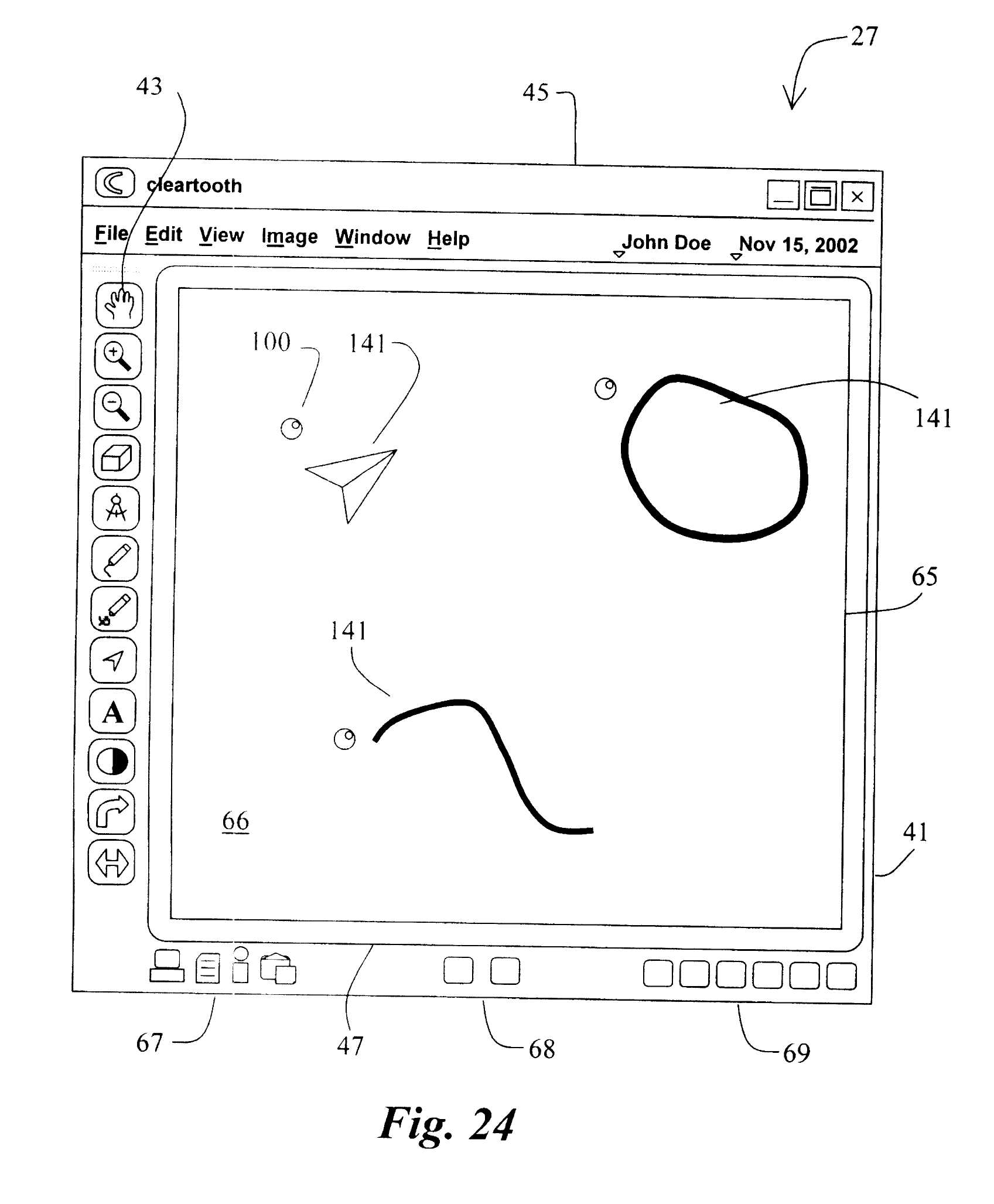

The graphical user interface 27 provides image manipulation through user commands that include a plurality of tools for enhancing and annotating the display of a digital image. The user commands are saved as recorded manipulations in the layered image record for the digital image. The annotations are displayed and recorded in layers, and the display of each layer may be toggled on or off as shown in FIGS. 23 and 24. The tools can include, by way of example and not as a limitation, as described above for the tear-off tool palette 43, point flag, move, zoom-in, zoom-out, erase, text, ink, highlight, measure, contrast, and orient. Each tool is designed to require the minimum number of user inputs, and user inputs are automatically saved in the image record.

Each annotation includes a jellybean 100, which is a colored dot near the display of the annotation. The color of the jellybean indicated the status of the annotation. When the jellybean is red, the selected annotation tool is active. When the user clicks on the red jellybean, the jellybean turns green and the annotation is stopped. When the user clicks on the green jellybean, the jellybean turns yellow and the annotation is hidden.

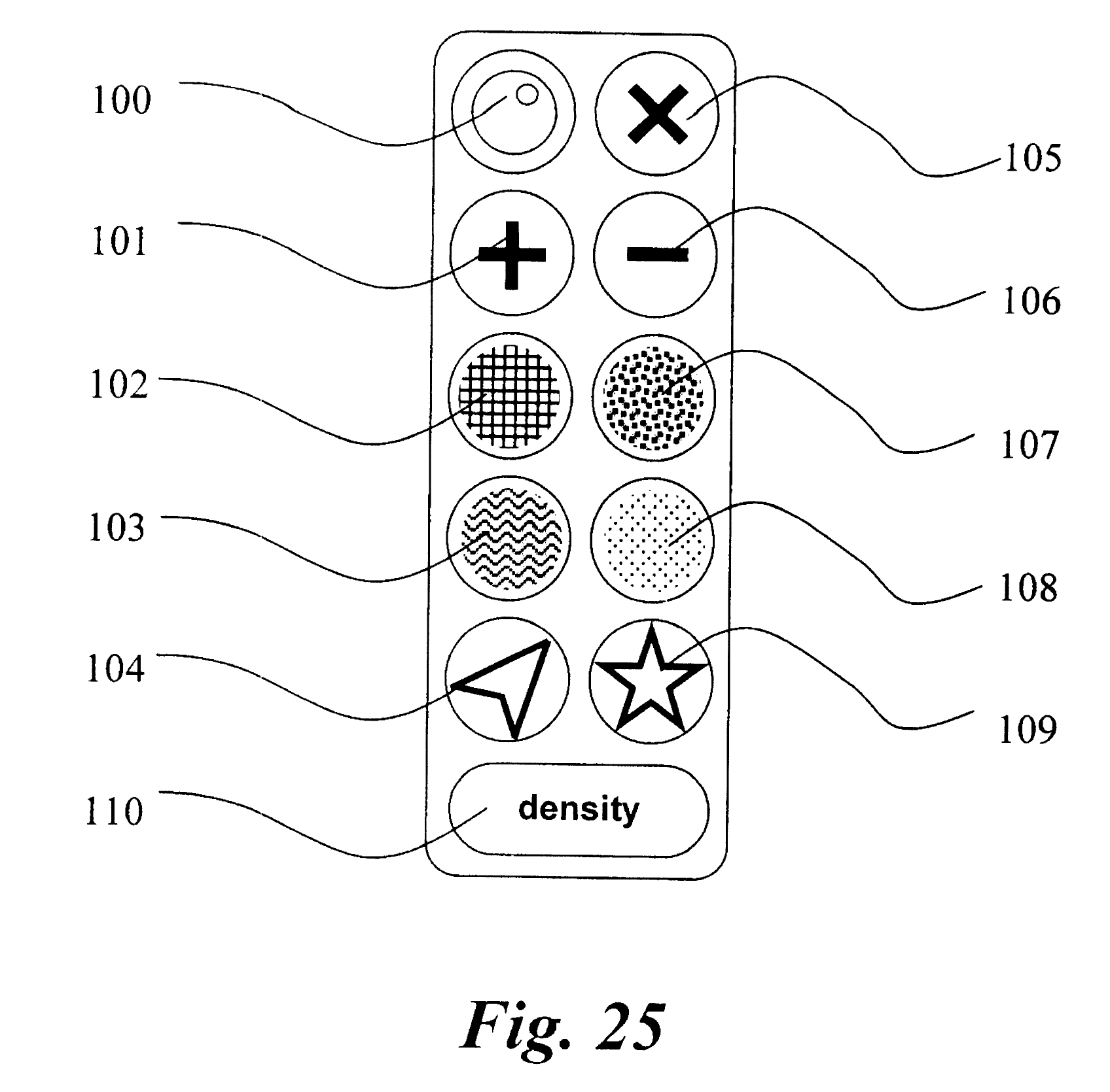

The user activates the point flag tool by selecting the point flag button 80, and the graphical user interface 27 displays a pointer shape. The user clicks on a location of interest in the active image panel 65 to create a point flag annotation. The user clicks on the jellybean to turn the jellybean green. When the user hovers over the green jellybean with the pointing device, a floating shape point flag control 98 is displayed, as shown in FIG. 25. The point flag control 98 is a substantially rectangular box with two columns each having five round buttons and a single oval button below. The buttons in the first column, from the top, include a jellybean button 100, an increase opacity button 101, a first color preset button 102, a third color preset button 103, and an arrow button 104. The buttons in the second column, from the top, include a delete button 105, a decrease opacity button 106, a second preset color button 107, a fourth preset color button 108, and a star button 109. Below the columns is the oval density button 110.

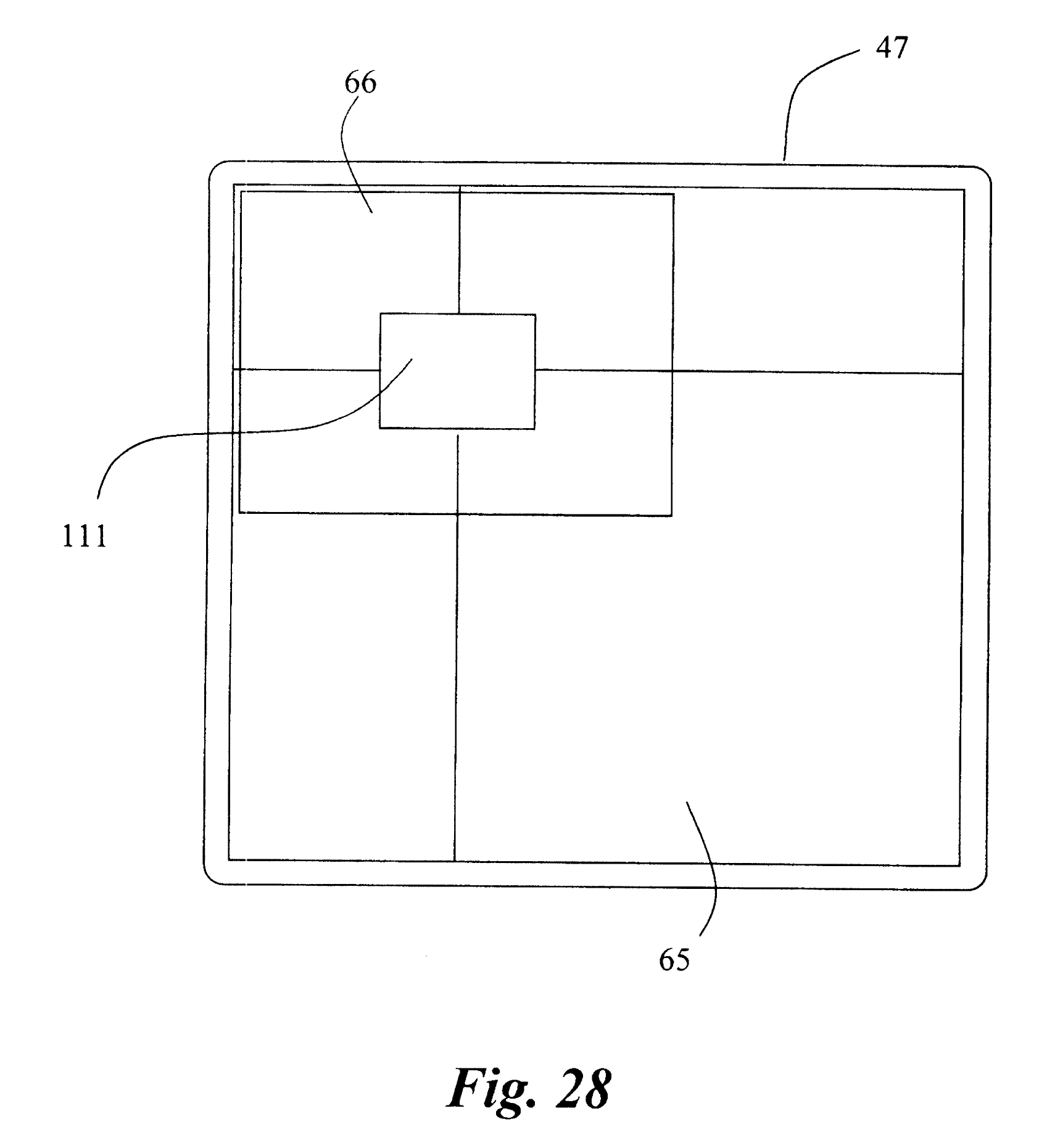

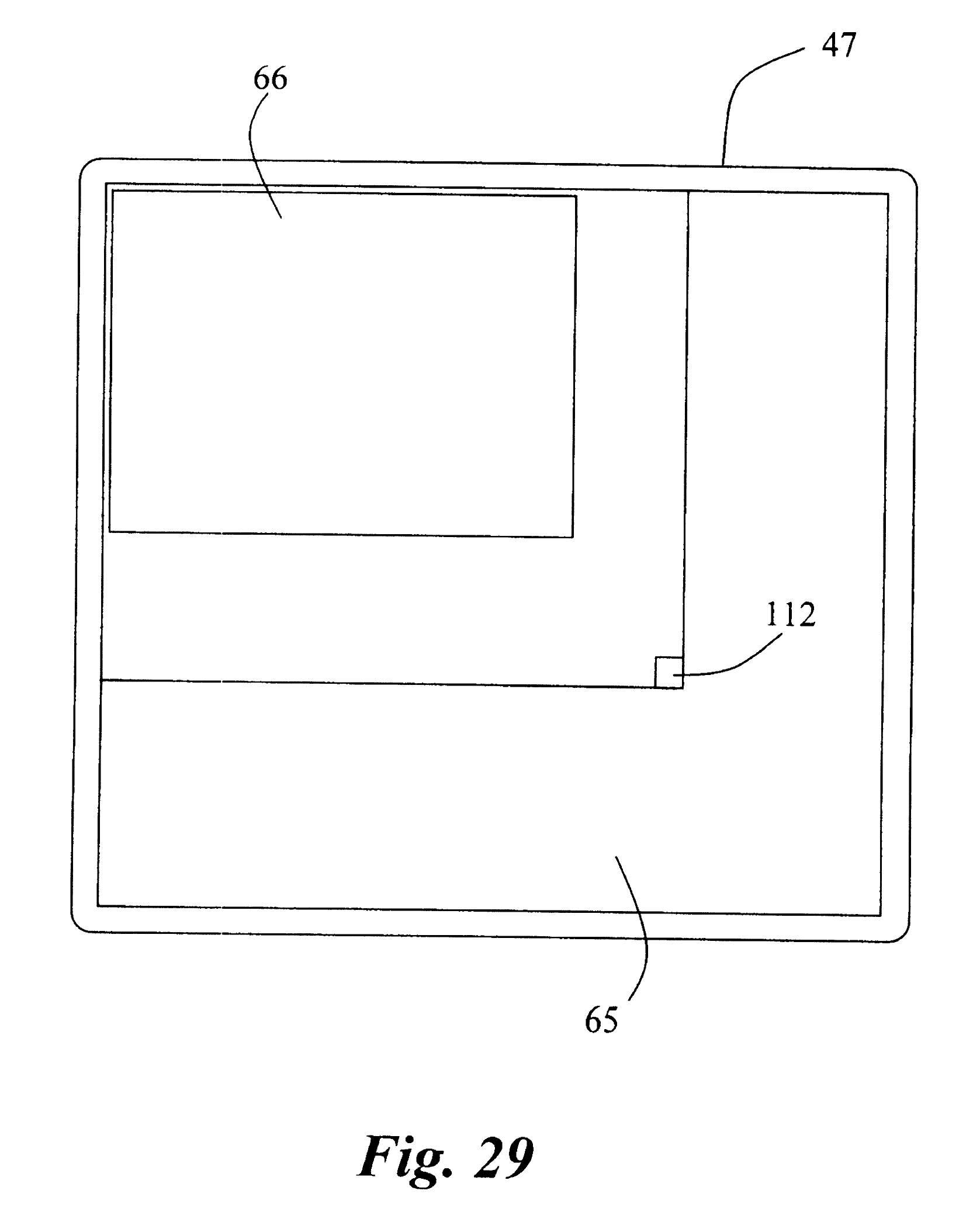

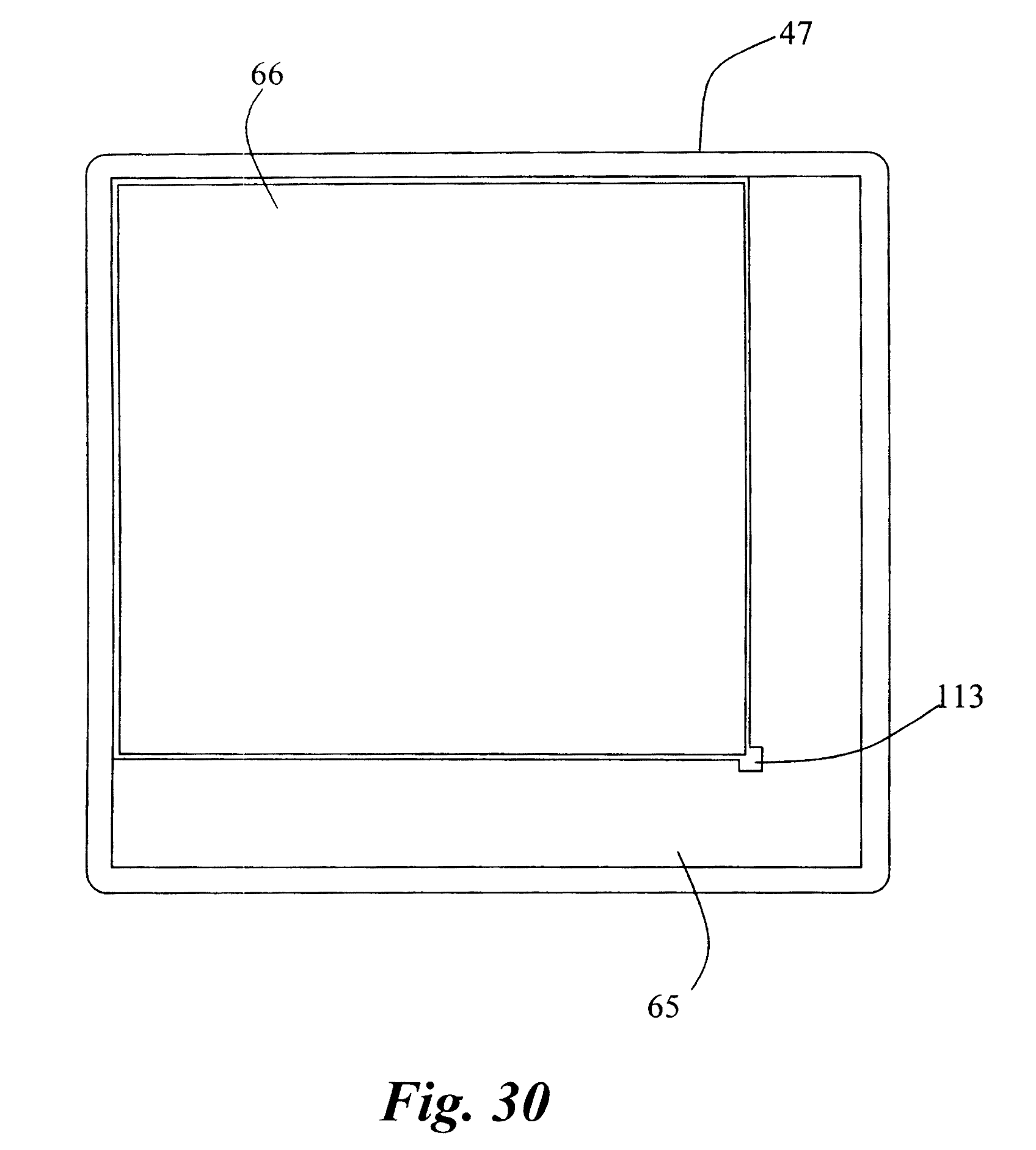

If the digital image in an image panel 65 is larger than the image panel 65, the user can select the move button 81 and translate the digital image within the image panel 65 to view different portions of the digital image. Referring to FIG. 28, when the user selects the zoom-in button 82, the graphical user interface 27 displays a zoom box 111 centered in the active image panel 65. The zoom box 111 is smaller than the image panel 65, and shows the ratio of the future zoomed image display to the current image display. If the user clicks on the zoom-in button 82 again, the size of the zoom box 111 is further reduced. When the user selects a point within the image panel, the graphical user interface 27 displays a zoomed image display centered about that point. If the user drags the system pointer outside of the image panel, the graphical user interface 27 displays a resize box 112, as shown in FIG. 29, and when the user upclicks, the graphical user interface 27 displays a resized image panel 65. When the zoom-out button 83 is selected the displayed size of the digital image is reduce by 20% or the shrink box 113 is displayed, as shown in FIG. 30, and the user can drag the system pointer inside the image and upclick to reduce the digital image size. After the upclick on zoom-in or zoom-out, the previous active tool is activated.

The erase tool, selected by clicking the erase button 84, provides selective deletion of previous annotations. Selection of the text 85, ink 86, or highlight 87 button provides for display and annotation in the text, ink or highlight layers, respectively.

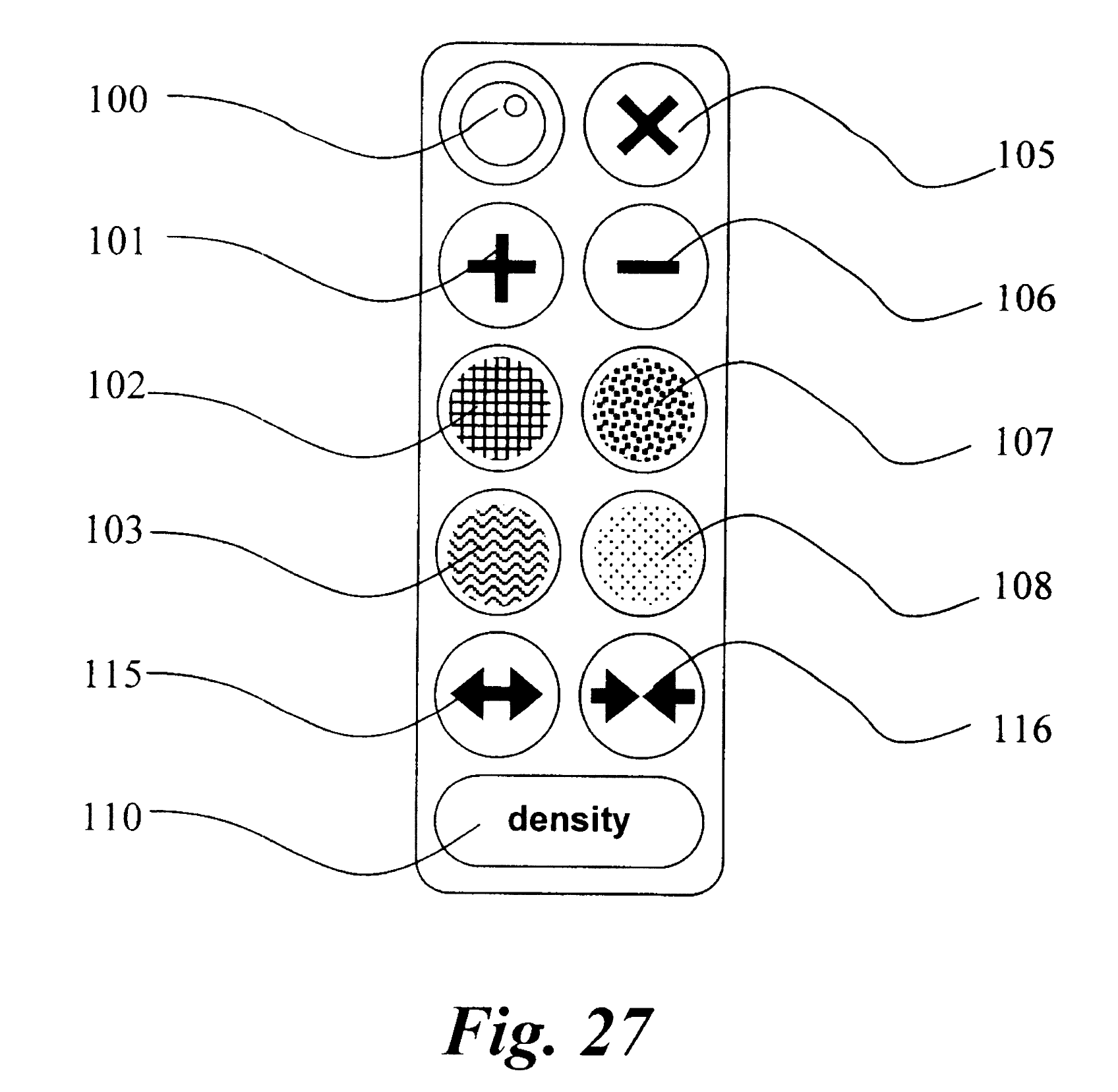

Referring to FIG. 27, when ink button 86 is selected and the user hovers over the green jellybean with the pointing device, the floating shape ink control 114 is a substantially rectangular box with two columns each having five round buttons and a single oval button below. The buttons in the first column, from the top, include a jellybean button 100, an increase opacity button 101, a first color preset button 102, a third color preset button 103, and thicker button 115. The buttons in the second column, from the top, include a delete button 105, a decrease opacity button 106, a second preset color button 107, a fourth preset color button 108, and a thinner button 116. Below the columns is the oval density button 110.

Referring to FIG. 27, when highlight button 87 is selected and the user hovers over the green jellybean with the pointing device, the graphical user interface 27 displays the floating shape highlight control 118, a substantially rectangular box with two columns each having four round buttons and a single oval button below. The buttons in the first column, from the top, include a jellybean button 100, an increase opacity button 101, a first color preset button 102, and a third color preset button 103. The buttons in the second column, from the top, include a delete button 105, a decrease opacity button 106, a second preset color button 107, and a fourth preset color button 108. Below the columns is the oval density button 110.

When the measure button 88 is selected, the user selects a first endpoint and a second endpoint in the active image panel 65, and the graphical user interface 27 displays a first line segment between the first and second endpoints and the distance between the first and second endpoints in true scale in millimeters. Measurements can be chained. When a third end point is chosen, the graphical user interface 27 displays a second line segment between the second and third endpoints, the distance between the second and third endpoints, and the angle between the first and second line segments.

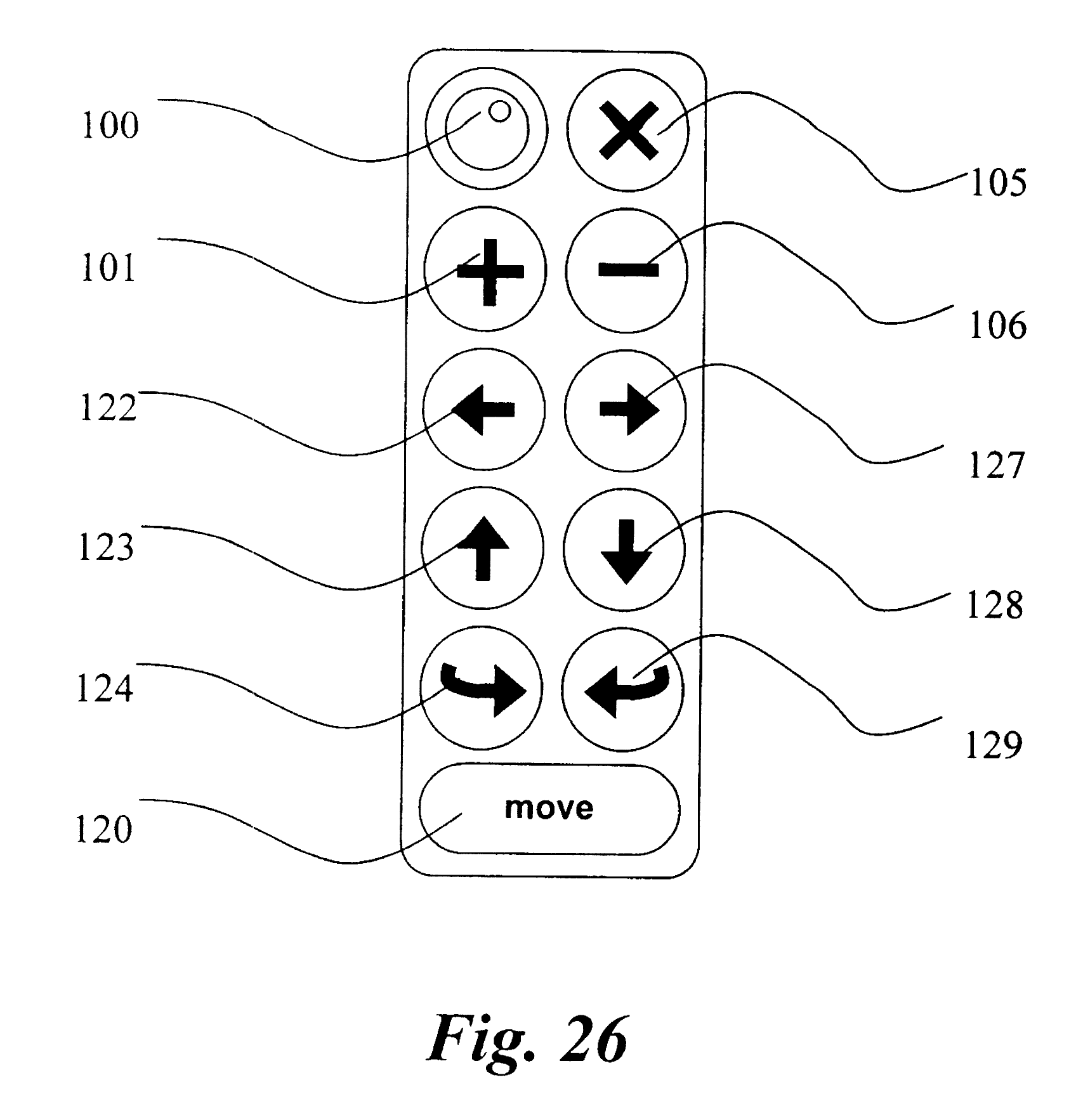

Referring to FIG. 26, when the user hovers over the green jellybean with the pointing device, the graphical user interface 27 displays the floating shape measure control 119, a substantially rectangular box with two columns each having five round buttons and a single oval button below. The buttons in the first column, from the top, include a jellybean button 100, stretch button 121, a nudge left button 122, a nudge up button 123, and a rotate counter-clockwise button 124. The buttons in the second column, from the top, include a delete button 105, shrink button 126, a nudge right button 127, a nudge down button 128, and a rotate clockwise button 129. Below the columns is the oval move button 120.

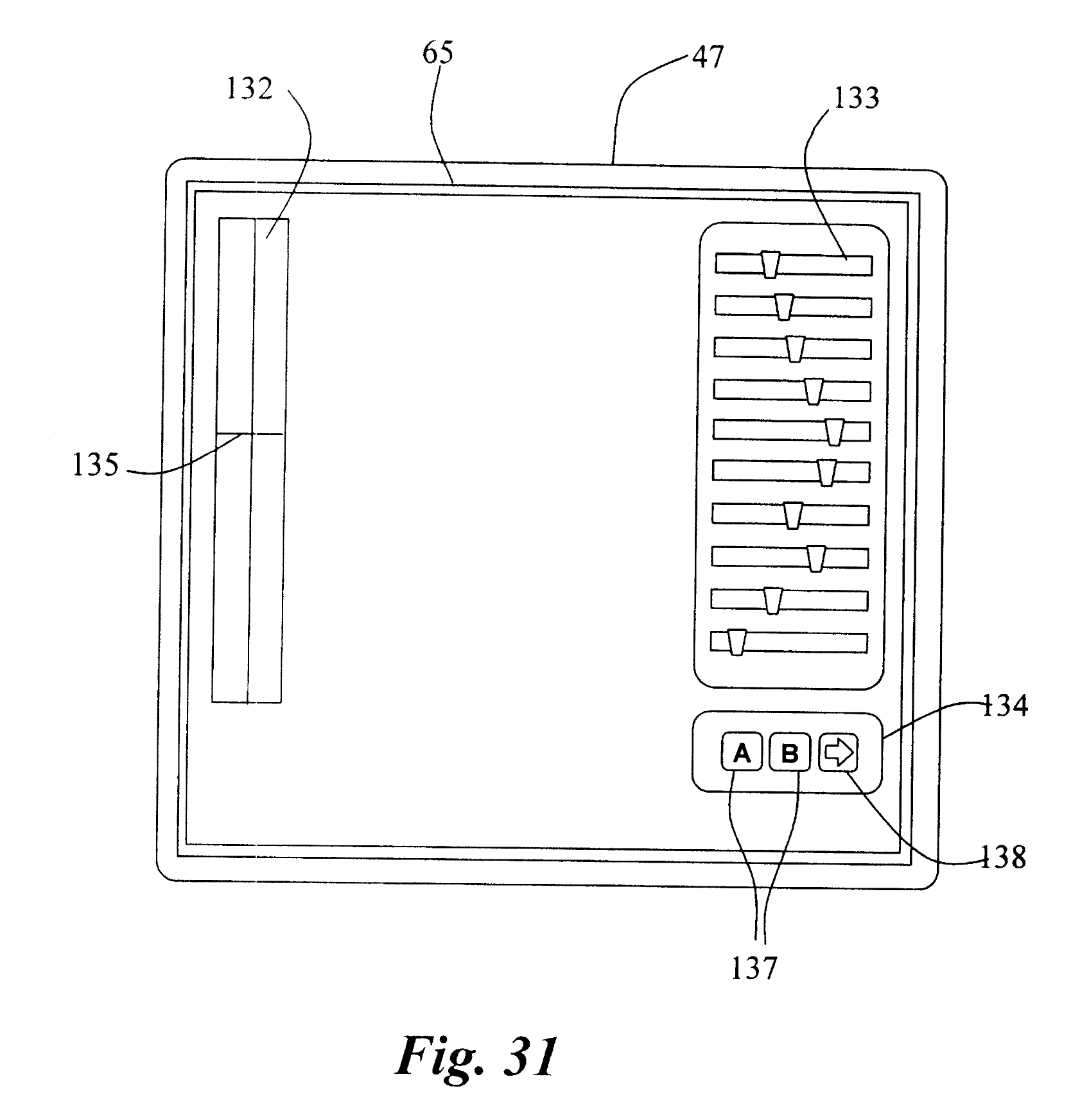

The contrast tool enhances the viewability of a digital image by selectively expanding ranges of the grayscale spectrum. Referring to FIG. 31, when the user selects the contrast button 89, the graphical user interface 27 displays semi-transparent contrast controls 131 in the active image panel 65, including two adjacent vertical gradient columns 132 near the left edge, a plurality of vertically spaced, horizontal slider controls 133 near the right edge, and a preset panel 134 below the slider controls 133. One gradient column 132 shows the original grayscale gradient and the other gradient column 132 shows the current grayscale gradient. When the user hovers over a point in the digital image, a grayscale level line 135 is displayed across the gradient columns 132, indicating the grayscale value of the point.

Each slider control 133 adjusts a range of grayscale values. The range of grayscale values corresponding to each slider control 133 is displayed in gradient columns 132 directly to the left of the slider control. When the user hovers over a point of interest in the digital image, the slider control 133 to the right of the grayscale level line 135 corresponds to the grayscale range of the point of interest. The user can drag the selected slider control 133 rightward to increase the range of grayscale value corresponding to the slider control 133, and thereby provide enhanced detail within the selected range. The graphical user interface 27 decreases the range of grayscale values for all other ranges in response to the increase in the selected range.

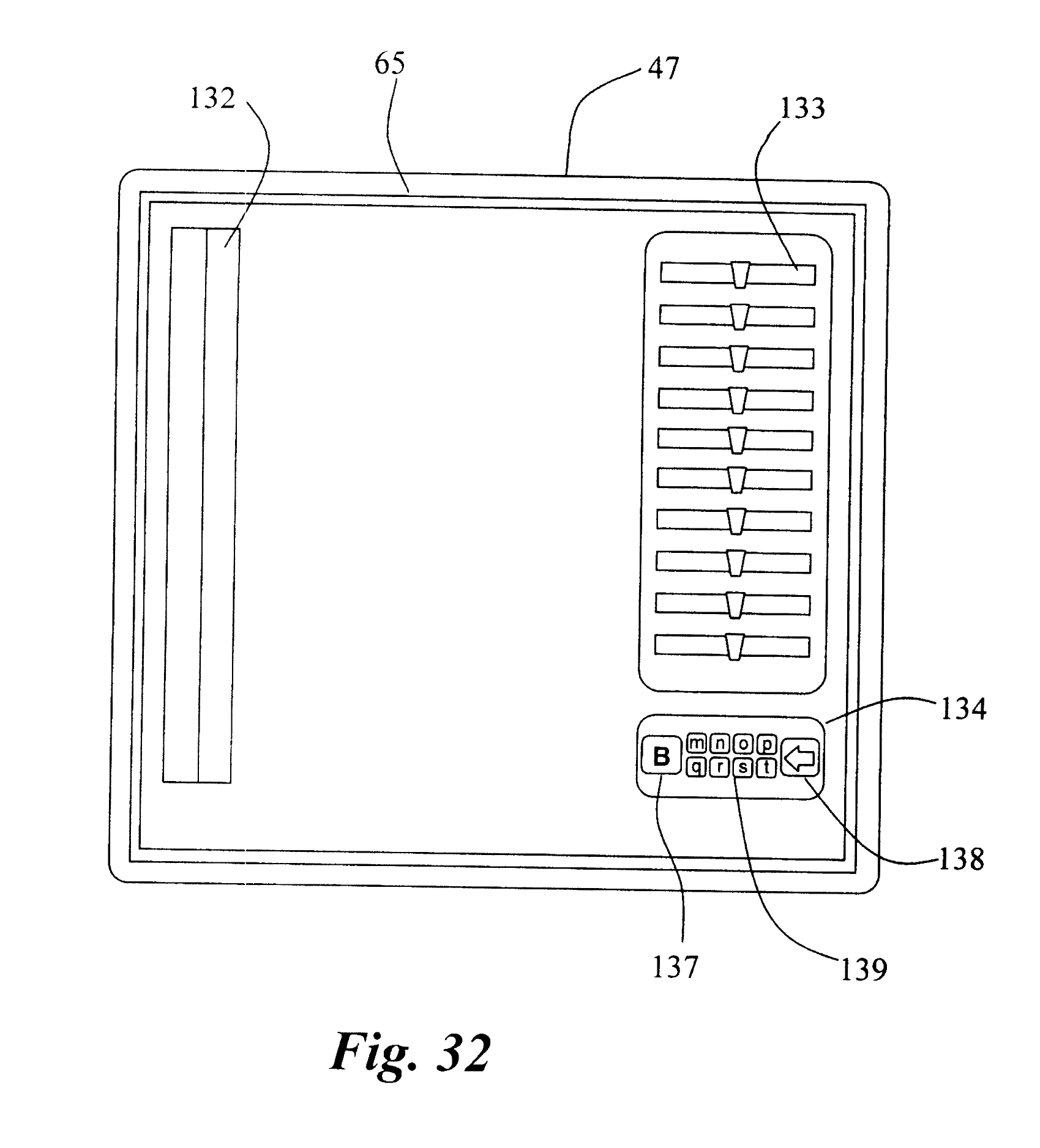

The preset panel 134 includes two channel buttons 137 and a preset open/close button 138. The graphical user interface 27 alternately displays two different contrast settings in response to selection between the two channel buttons 137. As shown in FIG. 32, when the preset open/close button 138 is selected, the graphical user interface 27 displays eight preset buttons 139 in place of one of the channel buttons 137. Referring to FIG. 20, two instances of the same digital image with different contrast settings can be viewed side by side in separate image panels 65.

The user selects the orient button 90 to correct orientation of the display of a digital image. For example, in the illustrated embodiment, where the digital image is a dental x-ray, the orientation of display of the digital image can be corrected so that the top teeth are on top. The image button palette on/off button 91 is selected to selectively display the image button palette 42.

Original digital images are stored in the cloud 32, increasing reliability and reducing system resources relative to systems where modified images must continually be saved. All image manipulations are recorded in the image records in the catalog service 29. The graphical user interface 27 provides a simple, intuitive interface for analysis and presentation to patients of the digital images. Use of touch-screen computers allows one-handed operation and more readily fits into the limited space of a dental operatory. Digital images are easily shared with the system of the present invention.

Although the present invention has been described with a certain degree of particularity, it is understood that the present disclosure has been made by way of example and that changes in details of structure may be made without departing from the spirit thereof.

1. A system for managing medical diagnostic digital images, comprising:
a file server operable to store said digital images and an image directory for said digital images,
a database server operable to store an image record for each said digital image,
a user workstation having an input device and a display device, and operable with a graphical user interface, said user interface being coupled to said file server and to said database server, said user interface being operable to create an image copy of a user selected digital image from said file server, to display said image copy on said display device, to receive user selected image manipulations of said selected digital image from said input device, to display said image manipulations with said image copy on said display device, and to automatically add said image manipulations to said image record for said selected digital image as recorded manipulations.

2. The system as set forth in claim 1 wherein said user interface is operable to access said image record of said user selected digital image and to display with said image copy said recorded manipulations from said image record.

3. The system as set forth in claim 2 wherein said image manipulations are added as commands and said recorded manipulations from said image record are displayed by executing said commands.

4. The system as set forth in claim 1 wherein said image manipulations are selected from the group consisting of move, zoom-in, zoom-out, rotate and contrast.

5. The system as set forth in claim 4 wherein said user interface is operable to display a zoom-in box centered in said image copy in response to user selection of said zoom-in and to display a zoomed in image of said image copy center around a point in response to user selection of said point after said zoom box is displayed.

6. The system as set forth in claim 4 wherein said user interface is operable to display a plurality of contrast controls with said image copy in response to user selection of said contrast manipulation, said contrast controls including a plurality of slider controls each representative of a grayscale range.

7. The system as set forth in claim 1 wherein manipulations include annotations.

8. The system as set forth in claim 7 wherein said annotations are selected from the group consisting of erase, text, pencil, highlight, point flag, measure and relative density.

9. The system as set forth in claim 1 wherein said user interface is operable to display on said display device an application window, an image button palette and a tear-off tool bar, said image copy being displayed in said application window.

10. The system as set forth in claim 9 wherein said tear-off tool bar is displayed at a user selectable location relative to said application window, said location being selected from inside said application window, outside and anchored to said application window, and outside and separate from said application window.

11. The system as set forth in claim 10 wherein said tear-off tool bar includes twelve tool buttons with each said tool button corresponding to a said image manipulation.

12. The system as set forth in claim 11 wherein said tool buttons include point flag, move, zoom in, zoom out, erase, text, ink, highlight, measure, contrast, orient, and image button palette on/off buttons.

13. The system as set forth in claim 11 wherein said user interface is operable to display said tool buttons in any rectangular arrangement with rows and columns where the number of rows multiplied by the number of columns equals twelve.

14. The system as set forth in claim 13 wherein said user interface is operable to display said tool buttons with similar functions in adjacent positions in each said arrangement.

15. The system as set forth in claim 9 wherein said user interface is operable to display thumbnail images of all said digital images in a series where said series includes all digital images of a patient from a single date.

16. The system as set forth in claim 9 wherein said user interface is operable to display a plurality of image layouts of said image copies of said digital images.

17. The system as set forth in claim 1 wherein said user interface is operable to associate, in response to user input from said input device, a patient name with said user selected digital image and to add said patient name to said image record for said user selected digital image.

18. The system as set forth in claim 1 including a removable data storage media device in communication with said file server and operable to receive said digital images from said file server and archive said digital images on removable data storage media.

19. The system as set forth in claim 18 wherein said file server is operable to store all unarchived digital images and said digital images that were most recently accessed by said user interface while reserving free file space for digital images, and to clear archived unused digital images.

20. The system as set forth in claim 1 including a digital image capture device in communication with said file server and said database server, said capture device being operable to capture a digital image, transmit said digital image to said file server and to notify said database server of said digital image;
wherein said file server is operable to automatically store said digital image and said database server is operable to create a said image record for said digital image in response to said notification.

21. The system as set forth in claim 1 wherein said input device and said display device are combined into a touch-screen with user input selections being displayed as buttons on said display device.

22. A system for managing medical diagnostic digital images, comprising:
a digital image capture device operable to capture digital images;
a file server operable to store said digital images and an image directory for said digital images, said file server being in communication with said capture device and operable to receive and automatically store said digital images from said capture device;
a database server operable to store an image record for each said digital image, wherein said database server is in communication with said capture device and is configured to receive notification of said digital images from said capture device and to create a said image record for each said digital image in response to said notification;
a user workstation having a touch-screen input and display device, and operable with a graphical user interface, wherein said user interface is coupled to said file server and to said database server, said user interface is operable to create an image copy of a user selected digital image from said file server, to display said image copy on said input and display device, to receive user selected image manipulations of said selected digital image from said input and display device, to display said image manipulations with said image copy on said input and display device, to automatically add said image manipulations to said image record for said selected digital image as recorded manipulations, to access said image record of said selected digital image, and to display said image copy with said user selected said recorded manipulations from said image record; wherein available said manipulations include move, zoom, rotate, contrast, and annotations; available said annotations include erase, text, pencil, highlight, point flag, measure and relative density; said user interface is configured to associate, in response to user input from said input device, a patient name with said selected digital image and to add said patient name to said image record for said selected digital image; and
a removable data storage media device in communication with said file server and operable to receive digital images from said file server and archive said digital images on removable data storage media, wherein said file server is operable to store all unarchived said digital images and said digital images that were most recently accessed by said user interface while reserving free file space for said digital images and to clear archived unused said digital images.

23. A method for managing medical diagnostic digital images, comprising the steps of:
providing a file server;
storing a plurality of said digital images in said file server;
providing a database server;
storing an image record in said database server for each said digital image;
providing a user workstation having an input device and a display device;
receiving a selection of a selected digital image from said input device;
displaying said selected digital image on said display device;
receiving a user command for an image manipulation of said selected digital image from said input device;
displaying said image manipulation with said selected digital image on said display device; and
adding said image manipulation to said image record for said selected digital image as a recorded manipulation.

24. The method as set forth in claim 23 including the step of displaying said recorded manipulation with said selected digital image on said display device.

25. The method as set forth in claim 24 wherein said image manipulation is added to said image record as said user command and said recorded manipulations are displayed by executing said user command.

26. The method as set forth in claim 23 wherein said image manipulation is selected from move, zoom, rotate, contrast and annotations.

27. The method as set forth in claim 26 wherein said annotations are selected from erase, text, pencil, highlight, point flag, measure and relative density.

28. The method as set forth in claim 23 including the steps of:
receiving a patient name from said input device; and
adding said patient name to said image record for said selected image.

29. The method as set forth in claim 23 including the steps of:
providing a digital image capture device;
capturing a digital image with said capture device;
storing said digital image on said file server; and
creating an image record for said digital image on said database server.

30. The method as set forth in claim 23 including the step of archiving said digital images to removable data storage media.

31. The method as set forth in claim 30 including the steps of:
maintaining all unarchived said digital images and said digital images that were most recently accessed on said file server while reserving free file space on said file server for new said digital images; and
clearing archived, unused said digital images from said file server.

32. A method for managing medical diagnostic digital images, comprising the steps of:
providing a digital image capture device;
providing a file server;
providing a database server;
providing a user workstation having an input device and a display device;
capturing digital images with said capture device;
storing said digital images on said file server in response to said step of capturing;
creating an image record for each said digital image on said database server in response to said step of capturing;
receiving a selection of a selected digital image from said input device;
displaying said selected digital image on said display device;
receiving a patient name from said input device; adding said patient name to said image record for said selected digital image;
receiving a user command for an image manipulation of said selected digital image from said input device, wherein said image manipulation is selected from a plurality of available input manipulations including move, zoom, rotate, contrast, and annotation; and said annotation is selected from erase, text, pencil, highlight, point flag, measure and relative density;
displaying said image manipulation with said selected digital image on said display device;
adding said user commend to said image record for said selected digital image as a recorded manipulation;
executing said user command to display said recorded manipulation with said selected digital image on said display device;
archiving said digital images to removable data storage media;
maintaining all unarchived said digital images and said digital images that were most recently accessed on said file server while reserving free file space on said file server for new said digital images; and
clearing archived, unused said digital images from said file server.

33. Software stored on computer storage media for managing medical diagnostic digital images, comprising:
a set of computer instructions for receiving a selection of a selected digital image from an input device, displaying said selected digital image on a display device, receiving image manipulations of said selected digital image from said input device, displaying said image manipulations with said selected digital image on said display device, and adding said image manipulations to an image record for said selected digital image on a database server as recorded manipulations.

34. The software as set forth in claim 33 wherein said image manipulations are selected from move, zoom, rotate, contrast and annotations.

35. The software as set forth in claim 34 wherein said annotations are selected from erase, text, pencil, highlight, point flag, measure and relative density.

36. The software as set forth in claim 33 wherein said set of instructions includes instructions for displaying said recorded manipulations with said selected digital image on said display device.

37. The software as set forth in claim 33 wherein said set of instructions includes instructions for receiving a patient name from said input device and adding said patient name to said image record for said selected image.

38. The software as set forth in claim 33 wherein said set of instructions includes instructions for displaying said recorded manipulations with said selected digital image on said display device.

39. The software as set forth in claim 33 wherein said set of instructions includes instructions for adding said image manipulations as commands and for executing said commands to display said recorded manipulations with said selected digital image on said display device.
